(19) United States
(12) Patent Application Publication
(10) Pub. No.: US 2026/0085602 A1
(43) Pub. Date: Mar. 26, 2026

(54) IMPROVED WELLBORE CONTROL AND MODELS USING IMAGE DATA SYSTEMS AND METHODS

(71) Applicant: DRILLDOCS COMPANY, Houston, TX (US)

(72) Inventors: Martin E. OEHLBECK, Cohocton, NY (US); Francois RUEL, Victoriaville (CA); Calvin Stuart HOLT, Houston, TX (US)

(21) Appl. No.: 18/876,451

(22) PCT Filed: Dec. 15, 2023
(86) PCT No.: PCT/US2023/084360

§ 371 Date: Dec. 18, 2024

Related U.S. Application Data
(60) Provisional application No. 63/433,421, filed on Dec. 16, 2022.

(51) Int. Cl. E21B 44/00; E21B 45/00; G06V 10/82; G06V 20/52

(52) U.S. Cl. CPC E21B 44/00; E21B 45/00; G06V 10/82; G06V 20/52

(57) ABSTRACT

Computer implemented methods and systems for testing one or more operational changes in a drill rig includes initiating the one or more operational changes and using, in part, image data of a mechanical mud separation machines (“MMSM”) to detect the impact of the one or more changes. The image data may be processed by a Deep Neural Network to identify objects in the object flow, operational parameters of the MMSM, and wellbore environmental conditions. Additional image data may be selected for additional processing based on the results of the analysis. The results of the test may be used to update the drilling operation or a drilling model.

### CLAIM OF PRIORITY

This application claims priority to and the benefit of U.S. Provisional Application No. 63/433,421 filed Dec. 16, 2022, titled “Improved Wellbore Control and Models using Image Data Systems and Methods,” the entirety of which is hereby incorporated by reference.

### BACKGROUND

The oil and gas industry often uses wellbore drilling to access reservoirs of oil and gas in underground features. Current techniques to access the wellbore formation include drilling into the ground using pipe and drill bits. Often fluid is pumped down the center of the well through the pipe to carry the bit cuttings up out of the well via the wellbore annulus. The fluid also serves as a force to stabilize the wellbore to prevent hole collapse during the drilling operation. Additionally, the fluid flow carries objects (including bit cuttings or cuttings) out of the wellbore in an object flow. The objects in the object flow are typically separated from the fluid by a mechanical mud separation machine (MMSM). The fluid is often then recycled back to the well.

Drilling engineers must control various drilling operational parameters to effectively, efficiently, and safely form the wellbore. These drilling operational parameters include drill speed, fluid density, flow rate, well pressure, etc. Improper control often leads to well formation failure. For example, too much fluid pressure in a wellbore could fracture the rock surrounding the wellbore too little pressure could lead to hole collapse.

Current methods of controlling operational wellbore parameters rely on, in part, predictive models. For example, prior ground surveys, historical well data, and estimated rock type may all be used to generate a computer model. These models estimate features of the well site, including drilling rates, lithology, wellbore rheology, and other drill site features (each of which forms a part of the wellbore state). In turn, the modeled or predicted features provide a recommended drill speed, fluid density, well pressure, flow rate, etc.

Issues arise, however, when the actual conditions at the drill site deviate from the predictive models. For example, an unanticipated change in rock type or formation pressure could render the recommended drilling operational parameters ineffective or worse. Continuing with the example, using recommended drilling operational parameters irrespective of the actual conditions could lead to well collapse, premature rock fracturing, equipment failure, loss of hole, and the like. Such problems occur at all stages of drilling.

Additionally, differences in real-time drilling conditions and computer models create operational inefficiencies, safety hazards, and well failure. For example, models may have inaccurately predicted drilling rates, lithology, wellbore rheology, and other drill site features (each of which forms, in part, the wellbore state). As such, operational parameters, such as drill speed, and the density/viscosity of fluid may be incorrectly set by drilling control programs. The result may be slower than necessary rate of penetration (ROP), well formation, wellbore collapse, premature fracturing, and/or wellbore instability, among other issues.

Wellbore issues have a significant adverse impact on production and reservoir potential. In addition to the capital and operating costs incurred when tools and time are lost attempting to recover or redrill sections, the cost of lost production when these attempts are unsuccessful is high. Thus, it remains desirous to design a system that may adjust modeling and operational parameters based on data collected during drilling a wellbore.

It is with these issues in mind, among others, that various aspects of the disclosure were conceived. Also, although relatively specific problems have been discussed, it should be understood that the embodiments presented should not be limited to solving the specific problems identified in the introduction.

### SUMMARY

This Summary is provided to introduce a selection of concepts in a simplified form that are further described below in the Detailed Description. This Summary is not intended to identify key factors or essential features of the claimed subject matter, nor is it intended to be used to limit the scope of the claimed subject matter.

To address some of the challenges described above, as well as other challenges, apparatuses, systems, and methods for using automatically detected wellbore objects in an image to improve wellbore computer models, identify issues with imaging system and system sensors (e.g., downhole sensors), and control wellbore operational parameters are described. For example, wellbore objects may be used to identify differences between the wellbore computer model, the expected wellbore output, and the imaged wellbore output. These differences may be used to update and/or identify issues with predictive computer models, identify issues with downhole sensors, and/or control wellbore and rig equipment, among other features.

In some aspects of the technology, wellbore objects are identified using a Deep Neural Network. The wellbore objects, along with other sensor data and other information, are correlated with certain wellbore states (e.g., hole size, drilling speed, wellbore lithology, etc.). Wellbore objects may include cuttings, cavings, fluid, retained fluid, rubble, metal, plastic, rubber, lost circulation material and other materials. In examples, a computer imaging system captures and tracks real-time object size distribution, object shape distribution, object color and object volume. The imaged objects may be compared to predicted objects (e.g., objects predicted by a computer model given depth of drill, operational parameters, etc.) and expected objects (e.g., objects an updated computer model expects to be imaged at the current time given updated wellbore state) to identify deviations.

These deviations may be used to identify issues with the computer model (e.g., a predicted wellbore state), wellbore penetration, fluid properties, wellbore hydraulics, equipment condition, direction, casings, wellbore volume, lag depth, hole conditioning, and/other drilling parameters. The systems described herein may be used to control various operational parameters and/or update predictive models to compensate for such deviations. For example, the system may automatically make adjustments to the operational parameters and/or update a computer model accordingly.

In additional aspects of the technology, one or more computing systems may adjust the one or more drilling parameters and/or computer model assumptions to determine the adjustments effect on the wellbore state as determined using image data. For example, flow rate, rate of penetration, weight on bit, fluid pressure, etc., may be adjusted. Image data may be used to determine the effect of such changes. By making such changes, a more optimal, safe, and or efficient drilling operation may be achieved.

More specifically, a computer may detect deviations between the predicted wellbore state and the actual wellbore state. This may occur by identifying deviations between what a computer model predicts and what is imaged at the drill site as it relates to various objects in an object flow, including a wellbore objects' size, size distribution, shape, color, type, absence, and/or presence, and volume during active drilling operations. This may lead to a better understanding of the current wellbore state, computer model accuracy, wellbore instrumentation accuracy, drilling effectiveness, and/or hole cleaning efficiency. Such imaging may be performed by an image detection system using a Deep Neural Network.

The relationship between deviations in these drilling parameters, operational conditions (e.g., current wellbore state), and predicted operation conditions (e.g., computer-modeled wellbore state) may be used in a number of ways, including:
Providing a Graphical User Interface illustrating the deviations between a computer-modeled wellbore state, an expected wellbore state, and an imaged wellbore state;
Providing information sufficient to update at least a portion of one or more computer models;
Determining the existence of underweighted fluid and over-pressured formations by detecting an increase in cavings, and deviations in the size, volume, and shape distribution of cuttings and cavings;
Determining the existence of washout and over gauge wellbore sections by detecting caving or tracer deviations in size, volume, and shape distribution;
Determining the existence of poor hole cleaning by detecting a decrease in cuttings recovery and deviations from the cuttings transport model; and
Allowing for the optimization of the operation of the drill rig (e.g., faster, safer drilling).

Information about the absolute and/or relative change in cutting volumes or other characteristics of cuttings coming off the shaker table may, under certain conditions, be combined with circulation system parameters and/or other drilling parameters, such as rate of penetration, and be used to generate a control request, update a predictive model (e.g., a computer model), and/or generate a graphical user interface.

Additionally, aspects of the technology relate to using object imaging and detection systems and methods to identify differences between predicted wellbore states, expected wellbore states, and imaged wellbore states. These systems and methods may be implemented at various mechanical mud separation machines (MMSM) of an oil and gas wellbore operation.

Image analysis, using a DNN for example, includes detecting various features of objects in an object flow, including object shape, size, type, volume, and other parameters of wellbore objects. Information from a rig, such as one captured by an electronic drilling recorder (“EDR”) and associated software platform, may also be used in combination with image data to monitor rig health, identify issues with computer models, update computer models, identify issues with downhole sensors, and/or control operational parameters of a wellbore. For example:
Image data may be used to identify deviations from modeled/expected object type, object size, object volume, and/or object distribution. Such deviations may indicate issues with model assumptions, downhole sensor information, and/or imaging systems.
A sudden change, either decreases or increases, in the cuttings volume not correlated to changing rate of penetration may indicate hole cleaning problems, influxes, and/or other changes in conditions. Additionally, a sudden change in the spatial characteristics of the cuttings may indicate a cave-in or other phenomena. Changes in size distribution of the cuttings may also indicate changes in morphology. Increases over the average volume of cuttings during drilling may indicate an increased rate of penetration; if the volume increases, and the rate of penetration does not, then a washout may have occurred. Outliers of an abnormal size may indicate drilling problems (e.g., increased metal cutting volume could indicate a broken bit). Trends in the data (e.g., consistent changes in shape, size, volume, according to threshold amounts of change of a selected time interval or intervals) may indicate progress or problems in an operation. Thus, the changes in data may be monitored as trends, and the trends may also be published for observation and action. Thus, the activity may comprise publishing trends in the data.
The changes in shape, size distribution, type, or volume of the down hole cuttings may be correlated to a number of operational conditions. Thus, the conditions associated with the borehole drilling or borehole pumping operations may comprise one or more of rate of penetration, formation pore pressure, weight on bit, drill pipe torque, or drilling angle.

The changes in shape, size distribution, or volume of the down hole cuttings may also be correlated to operational efficiency, such as drill bit cutting efficiency or sweeping efficiency. Thus, a running indication of efficiency may be identified, if desired. Therefore, the activity may comprise indicating an efficiency of a borehole drilling operation or a borehole pumping operation as a sweeping operation based on the image data along with other operational data. This may be compared to the computer modeled data. For example, the systems and methods described herein may:
Determine the existence of transition regions to salt, tar, or karst formations by detecting rubble rocks and deviations in the rubble and controlling the operational parameters based on the same.
Determine the absence or presence of fluid and its retention on a wellbore object by detecting its light reflection and color.
Determine the rig fluid processing efficiency by detecting the ratio of liquids versus wellbore objects. This information may also be used to optimize, improve, or adjust the shale-shaker angle (saving mud, and/or increasing efficiency); alert an operator to expected and/or unexpected changes in the cuttings volumes which may, in some cases, be indicative of hole cleaning, influx, losses, and/or other problems; and show whether or not the volume and characteristics of cuttings exiting the shaker is less than, greater than or approximately commensurate with the rate of penetration (“ROP”).
Determine the efficiency of lost circulation material (LCM) in weak, fractured or under-pressured formations by detecting the presence or absence of the materials size, shape, and volume returned at the MMSM.
Measure the confidence and probability of hole cleanliness and/or stability by combining data generated by the system for determining and controlling wellbore stability with a real-time expert knowledge-based system, including probabilistic and physics models and Bayesian methods.
Determine drilling and pumping equipment conditions by detecting non-formation of wellbore objects, including metal, plastic, and rubber objects.
Determine drilling bit efficiency through analysis of cutting size, shape, and volume.
Identify equipment failures, both anticipated and unplanned, including BHA and rig pump metal, plastic, and rubber components.
Determine sweep efficiency by monitoring wellbore objects volume during a sweep operation (e.g., the volume of wellbore objects cuttings may increase with increasing sweep efficiency and then may decrease as wellbore objects cuttings are moved out of the hole).
Determine the efficiency of bottom hole assembly (BHA) tools hole cleaning capabilities.
Determine deviations in a geological formation composition by monitoring cutting size, size distribution, color, and shape.
Detect deviations in baseline size, volume, and shape of cavings, which may indicate the fluid rheology needs adjusting.
Detect deviations in the size and sphericity (e.g., due to grinding) of objects, which may indicate inadequate object transport properties in the predictive models (e.g., cuttings transport model, geomechanics models) due to dynamic wellbore geometry deviations, wellbore instability or inadequate wellbore stability.
Detect the absence/presence of objects, which may result in the determination of deviations from normal operations (e.g., the lack of objects detected may indicate a MMSM not operating when it should be, the presence of fluid in the ROI may indicate a MMSM is not operating efficiently, and the absence of metal, plastic or rubber may indicate operations are normal).
Determine the fluid rheology information based on the height of the object flow bouncing in the shale shaker.

Each action above may be used to compare a predicted wellbore state (e.g., as predicted by a computer model), an expected well bore state (e.g., as expected with the current drilling operational parameters and sensor data), and an imaged well bore state (e.g., as determined through image data).

These and other aspects, features, and benefits of the present disclosure will become apparent from the following detailed written description of the preferred embodiments and aspects taken in conjunction with the following drawings, although variations and modifications thereto may be affected without departing from the spirit and scope of the novel concepts of the disclosure.

### BRIEF DESCRIPTION OF THE DRAWINGS

The accompanying drawings illustrate embodiments and/or aspects of the technology. These drawings, along with the written description, serve to explain the principles of the disclosure. Wherever possible, the same reference numbers are used throughout the drawings to refer to the same or like elements of an embodiment, and wherein:

FIG. 1 provides an example of a drilling operation in which one or more aspects of the technology may be employed;

FIG. 2 is an example of a networked environment in which the systems and

methods described herein may operate;

FIG. 3 is a diagram illustrating a managed pressure drilling (MPD) system according to an example of the instant disclosure;

FIGS. 4A and 4B illustrate an example change in an ROI of a field of view between a first time (T1) and a second time (T2);

FIG. 5 is an example illustration of channels of an MMSM having a screen;

FIG. 6 illustrates example communications signals between a wellbore stability and control application, an image capture and detection application, and a rig control application;

FIG. 7 is a method for setting an ROI;

FIG. 8 is a method of performing object imaging and detection of objects in one or more MMSMs by the object imaging and detection application according to an example of the instant disclosure;

FIG. 9 is a method for updating a predictive model based on received image data;

FIG. 10 is a method for identifying a variance between expected image data based on downhole sensors and other operational parameters and detected objects;

FIG. 11 is a method for controlling one or more rig parameters based on received image data;

FIG. 12 illustrates a method of measuring the volume and/or mass of a shaker load coming across the shaker using a vision system;

FIG. 13 is a wellbore hole;

FIG. 14 is a method to determine a deviation from a computer model and/or expected images from actually image data;

FIG. 15 is a method of optimizing a wellbore through changes;

FIG. 16 illustrates an example operating environment, which typically includes at least some form of computer-readable media;

FIG. 17 is a block diagram illustrating additional physical components (e.g., hardware) of a computing device with which certain aspects of the disclosure may be practiced; and

FIG. 18 illustrates and example graphical user interface (“GUI”) showing the deviations from modeled objects, expected objects, and imaged objects.

FIGS. 19A and 19B illustrate example graphical user interfaces that may be used with the technology disclosed herein.

### DETAILED DESCRIPTION

Aspects of the technology relate to computer-automated imaging systems and methods to capture, analyze, characterize, and/or identify objects in an object flow of a wellbore operation. In examples, the objects are identified using a Deep Neural Network (“DNN”). Additional image aspects may be analyzed, such as other physical objects in an image (e.g., a person). These images may be used to identify deviations between predicted images, expected images, and current images, which in turn may be used to update computer models, identify issues with down hole sensor equipment, and identify issues with one or more imaging systems.

In aspects of the technology, an imaging device, such as a camera, may be used to capture images of the return flow (or other flow) of one or more MMSMs. The imaging device may capture images of debris, cuttings, liquid, and/or other material of the object flow. The DNN may be used to analyze the image. Such analysis may include detecting and characterizing objects (such as cuttings from a drill) in the image. The images of the objects may be used to identify the object size distribution, object shape distribution, object color, object volume deviations and/or other parameters, which may be tracked over time and associated with the positional information of a drill bit in a drill rig and/or compared to a computer modeled output.

Additionally/alternatively, the identified objects may be used to identify operational attributes of a wellbore. For example, the system may identify well productivity zones, well-hazard zones, fluid properties, wellbore hydraulics, equipment condition, and the like based on the identified wellbore cuttings and other information.

Aspects of the technology also relate to dynamically changing the image device settings, image type, image number, and image size/shape based on objects detected. For example, where object detection and classification indicates an anomaly, the system may automatically begin to capture and/or process more imaging information to confirm and or expand information related to these anomalies. One advantage of these aspects is that it allows processing speed and bandwidth to be relatively conserved when no anomaly is detected.

The information may be compressed, translated, or otherwise modified to facilitate communication to a location other than the location where the image was captured. For example, the image data may be compressed/translated such that the data may be transmitted from an off-shore drilling operation to an on-shore analytics and monitoring station relatively faster than sending all the imaging data. The real-time information may be presented to a drill team. The information may include flagged anomalies in the object characteristics and/or operational indicators. This information may be combined with other rig-based data to communicate one or more conditions associated with the rig equipment and/or the wellbore.

By applying automated, computer-based video interpretation, continuous, robust, and accurate assessment of many different phenomena may be achieved through pre-existing or real-time video data without requiring continuous manual monitoring. The technology described herein may be employed to improve performance across a wide range of video-based sensing tasks compared to the prior technology. For example, aspects of the technology may be used to improve safety, reduce costs, and improve efficiency.

The technology described herein may be used to capture images at one or more MMSMs. The captured images may contain objects in an object flow of an MMSM and other objects (such as people on the periphery of the image attending to the MMSM, the MMSM itself, and equipment of the MMSM such as screens). The captured image may also contain image distortions due to interference with image capture, such as overexposure, signal noise, etc. The information captured by the image, or image aspects, may be analyzed using the technologies described herein.

For example, an image may include objects in an object flow from a wellbore of a drilling rig. In the typical function of a drilling rig, fluid is pumped into the wellbore and back up the wellbore. As the fluid returns from the wellbore, it may carry with it solid material and semisolid material. This flow of objects is referred to herein as object flow. These objects may be predominately cuttings drilled by the drilling bit and are typically separated from the fluid using multiple mechanical mud separation machines including primary shale shakers, dry shakers, hydrocyclones, or centrifuges, among others. In addition to fluid or cuttings, other objects may include wellbore cavings, metal, rubber, cement, rubble, or tracers.

The object flow coming from the wellbore commonly passes into an MMSM which separates the debris from useable fluids/solids for re-circulation in a drilling operation. This separation process may occur one or more times and is accomplished by various devices such as shakers, dryers, centrifuges, and the processing pit. Often when such a separation process occurs, the object flow is split into at least one flow that is relatively drier and at least one flow that is relatively wetter. Multiple mechanical mud separation machines (MMSM) may be used in series or parallel to separate liquids from wellbore solids to facilitate liquid reuse. Typically, the first MMSM that encounters the returning object flow is the primary shale shaker which may have one or more screening tables. A shale shaker is the most common MMSM.

The shaker may include one or more screening decks, such as a top screening deck, one or more middle screening decks, and/or a bottom screening deck. Motors may also be attached to the shaker to impart vibratory motion on the shaker to assist with separating the object flow within the shaker as it transfers to another MMSM or waste pit. An MMSM may be the dryer shaker, centrifuge, and hydrocyclones, among other devices. As further described below, imaging systems may be used with a shaker table but may also be used to image objects in an object flow of other types of MMSMs.

Aspects of the present technology may be used to improve on the manual observation techniques currently practiced. For example, automated detection of objects in an object flow and/or classification of wellbore/drilling/equipment condition based on captured images may be employed to reduce wellbore failure (such as identified by the presence of cavings) and/or equipment malfunctions (e.g., as identified by the presence of metal). For example, the systems and methods described herein may be used to output likely well and equipment failures. In turn, such output may be used by well operators to improve efficiency, safety, and environmental impact during the drilling operation.

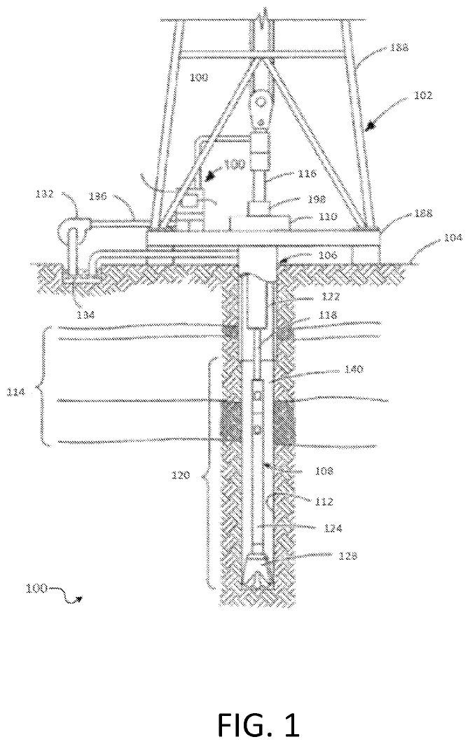

Turning now to the figures. FIG. 1 provides an example of a drilling operation 100 in which one or more aspects of the technology may be employed. FIG. 1 illustrates a drilling rig 102 that may be located at the surface 104 of a well 106. Drilling of oil, gas, and geothermal wells is commonly carried out using a string of drill pipes or casings connected to a drilling string 108 that is lowered through a rotary table 110 into a wellbore or borehole 112. Here a drilling platform 186 is equipped with a derrick 188 that supports a hoist.

As illustrated, the drilling rig of 102 provides support for the drill string 108. The drill string 108 may operate to penetrate the rotary table 110 for drilling the borehole 112 through subsurface formations 114. The drill string 108 may include a Kelly 116, drill pipe 118, and a bottom hole assembly 120, perhaps located at the lower portion of the drill pipe 118.

The bottom hole assembly (BHA) 120 may include drill collars 122, a down hole tool 124, and a drill bit or float equipment 126 attached to casings for cementing. The drill bit or float equipment 126 may operate to create a borehole 112 by penetrating the surface 104 and subsurface formations 114. The down hole tool 124 may comprise any of a number of different types of tools, including MWD tools, LWD tools, casing tools and cementing tools, and others.

During drilling operations, the drill or casing string 108 (perhaps including the Kelly 116, the drill or casing pipe 118, and the bottom hole assembly 120) may be rotated by the rotary table 110. In addition to, or alternatively, the bottom hole assembly 120 may also be rotated by a motor (e.g., a mud motor) that is located down hole. The drill collars 122 may be used to add weight to the drill bit or float equipment 126.

The drill collars 122 may also operate to stiffen the bottom hole assembly 120, allowing the bottom hole assembly 120 to transfer the added weight to the drill bit and in turn, to assist the drill bit in penetrating the surface 104 and subsurface formations 114.

During drilling and pumping operations, a pump 132 may pump fluids (sometimes known by those of ordinary skill in the art as “drilling mud,” “cement,” “pills,” “spacers,” “sweeps,” “slugs”) from a processing pit 134 through a hose 136 into the drill pipe or casing 118 and down to the drill bit float equipment 126. In operation, the fluid may flow out from the drill bit or float equipment 126 and be returned to the surface 104 through an annular area 140 between the drill pipe or casing 118 and the sides of the wellbore borehole 112. The fluid may then be returned to the processing pit 134, where such fluid is processed (e.g., filtered). In some embodiments, the fluid may be used to cool the drill bit 126, as well as to provide lubrication for the drill bit 126 during drilling operations. Additionally, the fluid may be used to cement the wellbore and case off the sub-surface formation 114. Additionally, the fluid may be used to remove other fluid types (e.g., cement, spacers, and others), including wellbore objects such as subsurface formation 114 objects created by operating the drill bit 126 and equipment failures.

The fluid circulated down the wellbore 112 to the processing pit 134 and back down the wellbore 112 has a density. Various operational parameters of the drill rig environment 100 may be controlled. For example, the density of the fluid, the flow rate of the fluid, and the pressure of the wellbore 112 may be controlled. Control of the various operational parameters may be accomplished using a computing system 156, which may run/store (or be in electronic communication with) a wellbore model update application, wellbore stability control application and/or a rig control application as described herein. It is the images of these objects that many embodiments operate to acquire and process. The drill rig, equipment, and bit, and other devices may be equipped with various sensors to monitor the operational performance of the rig, and these sensors may be in electronic communication with the computing system 156. In aspects of the technology, computing system 156 is the same or similar to the computing devices described with reference to the figures below and/or and EDR system.

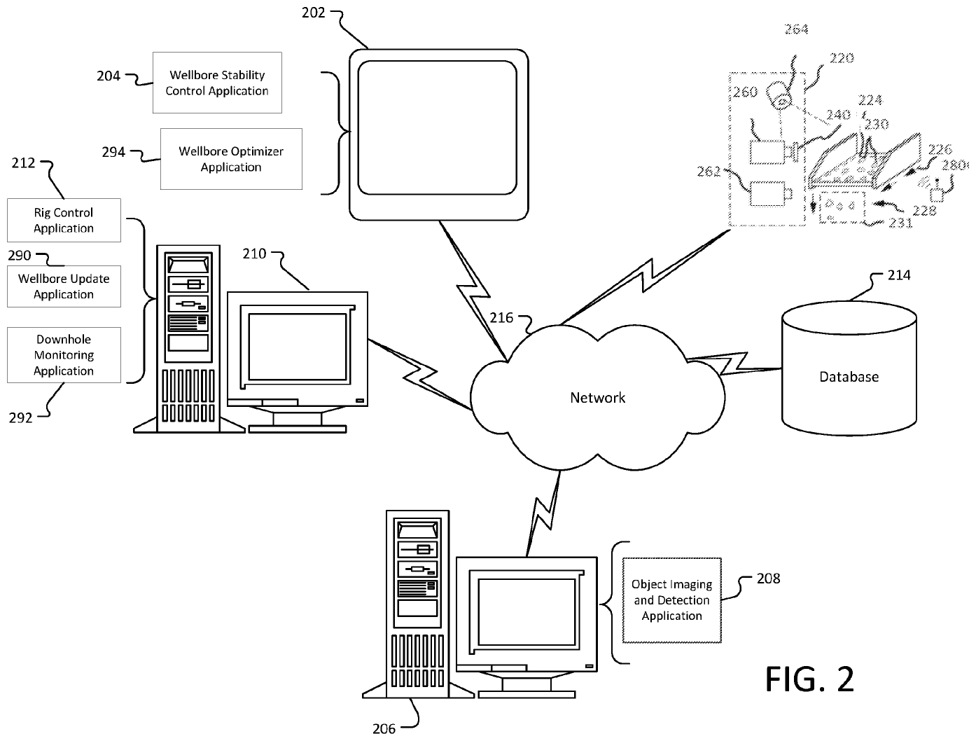

FIG. 2 is an example of a networked environment 200 in which the systems and methods described herein may operate. As illustrated, FIG. 2 includes a first computing device 202 storing a wellbore stability control application 204 and a wellbore optimizer application 294, a second computing device 206 storing an object imaging and detection application 208, and a third computing device 210 storing a rig control application 212, a wellbore model update application 290, and a downhole monitoring application 292. It will be appreciated that though each application is shown on a single computing device, the applications may be run on a single computer or more than the computers shown as further described herein. Additionally illustrated is a storage device 214. The first computing device 202, the second computing device 206, the third computing device 210, and the storage device 214 is in electronic communication via a network 216.

In examples, a wellbore stability control application 204 receives information from the object imaging and detection application 208, the rig control application 212, the vision system 220, and/or the downhole monitoring application 212 (referred hereinafter as System 200 data). Using some or all of the received information the wellbore stability and control application 204 determines one or more wellbore operational parameters to adjust, and/or the wellbore stability and control application determines various wellbore features to report, which wellbore features may be different than a predictive model's assumed wellbore features. The wellbore control application 204 then sends information sufficient to adjust the operational parameters. In aspects of the technology, wellbore stability and control application 204 sends a request to the rig control application 212 to make such adjustments. For example, based on the received information, the wellbore stability control application 204 may send signals to various pumps, valves, and/or hoppers to change pump speed, actuate a valve, or add material to a fluid (or signals sufficient to cause such a change, such as a request signal)

A wellbore optimizer application 294 may cause the change of various operational parameters and/or model assumptions. Additionally, the wellbore optimizer application 294 may receive image data to determine whether the changes to the operational parameters and/or model assumptions had an impact. For example, wellbore optimizer application 294 may request a change from rig control application 212 and/or a change from the wellbore update application 290 and monitor to see whether/what impact such change had on the rock types being image captured at the one or more MMSMs. Monitoring may occur by receiving image data from the object detection application 208.

Additionally, a wellbore model update application 290 receives information from the object imaging and detection application 208, the rig control application 212, and/or the vision system 220 (i.e., the System 200 data), among other data. The wellbore model update application 290 may receive other data, such as data from an EDR or other information related to the wellbore model. Using some or all of the received information the wellbore model update application 290 determines whether a deviation exists between modeled wellbore state and the imaged wellbore state. The wellbore model update application 290 may then send a request to update the computer model to an EDR or another application, generate a report or GUI indicating the deviation, or trigger an alarm. In aspects of the technology, wellbore model update application 290 sends a request to a computer application, such as an EDR to make adjustments to the computer model.

Additionally, a downhole monitoring application 292 receives information from the object imaging and detection application 208, the rig control application 212, and/or the vision system 220 (i.e., the System 200 data), among other data. The downhole monitoring application 292 may receive other data, such as data from an EDR or other information related to the wellbore model. Using some or all of the received information, the downhole monitoring application 292 determines whether a deviation exists between an expected wellbore state (e.g., as determine by current drill depth, bit speed, weight on bit, fluid density, etc.) and the imaged wellbore state/actual downhole readings (e.g., pressure, flowrate, temperature, etc.). The downhole monitoring application 292 may then send a request to the rig control application to halt drilling (or take some other action), generate a report or GUI indicating the deviation, or trigger an alarm. In aspects of the technology, downhole monitoring application 292 sends a request to a computer application, such as an EDR to make adjustments to the computer model.

Object imaging and detection application 208 receives information from a vision system 220. In examples, image vision system 220, captures images having two regions of interest (“ROI”), namely a first ROI 224 and a second ROI 231. ROIs are areas within a field of view of an imaging device that are selected for image analysis, such as analysis by object detection using a DNN as further described herein. There may be one or more, such as two, three, four, five, etc., ROIs within a field of view. In aspects of the technology, an ROI is a portion of a captured image (e.g., the portion may be of a certain size within a field of view). Further, the portion of the ROI may be consistent over a period of time. The image data captured within the ROI may be associated with a time stamp corresponding to the time at which the image data was captured.

In some examples, image vision system 220 has one or more imaging devices. It will be appreciated that a single imaging device may be used to capture a large field of view from which one or more ROIs may be selected. As illustrated, the image vision system 220 has a first imaging device 260 and a second imaging device 262. Imaging devices, such as first imaging device 260 and second imaging device 262, may be any device suitable to capture images of objects in an object flow, including objects flowing through an MMSM. Such imaging devices include charge couple device (CCD) cameras. Complementary Metal Oxide Semiconductor cameras, high-resolution cameras, visible light cameras, low light or infrared cameras, and/or LiDAR imaging devices. In some applications, the vision system 220 may capture 3D profiles of objects in an object flow using one or more imaging devices that relate to LiDAR, stereo cameras, ultrasound sensors, or electromagnetic waves sensors, and/or other imaging devices now known or later developed capable of capturing 3D images.

Also illustrated is an additional light source 264. In aspects, one or more additional light sources 264 illuminates objects in an object flow (or other objects in a field of view), such as object flow 226. A light source may be an ultraviolet light, an incandescent light, a white light, tungsten light, infrared light, or light-emitting diodes (LEDs) to illuminate wellbore objects. The light source may be capable of generating various types of light, including near, mid, or far wave infrared lights, the visible spectrum, ultraviolet like, and the like.

The vision system 220 is illustrated in network communication with the various computing devices, such as a first computing device 202, a second computing device 206, and a third computing device 210. In aspects of the technology, the vision system 220 may transmit real-time information from imaging devices, including ROIs. In some aspects of the technology, the entire field of view of the imaging device is sent to a computing device 202 and/or a storage device 214. In other aspects, only the ROI is sent to the computing device 202 and/or the storage device 214. The image information may include wellbore object image information. The computing device 202 may be configured to process the image information. Such processing includes automatically identifying/classifying wellbore objects in the image as further described herein (e.g., using a DNN).

It will be appreciated that various ancillary devices may be employed with image vision system 220 without deviating from the scope of the innovative technology. For example, various lenses, filters, enclosures, wipers, hoods, lighting, power supply, a cleaning system, brackets, and mounting devices may comprise image system 220. Further, one or more of a mechanical camera stabilizer, a camera fog stabilizer, or the like may be employed. Image system 220 may be designed to operate in outdoor, harsh, all-weather, hazardous areas, and/or 24 hours per day. The enclosure and its components may be watertight, explosion-proof, and/or intrinsically safe.

Vision system 220 also includes modification device 240. In examples, one or more modification devices may be employed to modify/reduce/focus the light (e.g., infrared/visible light/ultraviolet light, etc.) captured from the objects in the object flow. For example, modification device 240 may be one or more of polarizers, filters, and/or beam splitters to intercept light reflected or emitted by the wellbore objects, such as objects 230, and to reduce the amount/type of light received by the imaging devices of the vision system 220.

For example, the modification devices 240 may be chosen based on the type of drilling fluid that is used. Polarizers may be used to align light energy in either the P or S directions (so that the processed energy is p-polarized, or s-polarized), or to give a blend of P and S polarized energy. Beam splitters may be used to reduce the spectrum of the received energy to some selected range of wavelengths. Filters may be used to further narrow the range to a select spectrum prior to image capture.

Additionally/alternatively, one or more modification devices 240, may be interposed between the objects 230 and/or the object flow 226 and the vision system 220 to reduce the number of wavelengths captured by the vision system 220. In examples, the reduction in wavelengths allows fluid and objects that may be in close proximity to other objects to become relatively transparent so that the other objects in the object flow are more prominently captured by the image devices of the vision system 220.

The energy modification devices may be adjustable to obtain a relatively strong image contrast for detection of the objects 230 within a fluid solution that has a dynamic composition. The selection of materials used in conjunction with the energy modification devices may depend on the hazards of the environment, including the chemical solutions present. These materials may include glass, polymers, and metals, among others.

In aspects of the technology, the images captured by vision system 220 include one or more ROIs. As illustrated, included is a first region of interest 224 and a second region of interest 231. The regions of interest may be selected to be a particular area of the MMSM, such as a falling zone of a shaker table or the entire MMSM. One or more ROIs may be selected and analyzed by an Object Imaging and Detection Application 208 to identify image aspects, including identifying objects in an object flow and identifying other objects in the ROI. Such identification may occur using a DNN. The region of interest may be automatically selected by the Object Imaging and Detection Application 208 as further provided herein. Further, though FIG. 2 illustrates identifying an ROI contemporaneous to the imaging devices capturing the image, it will be appreciated that an ROI may be determined after the image is captured. Such determination may be applied to historical data stored in a database, such as storage device 214.

One or more environmental sensors 280 may be part of the vision system 220 to aid in image rendering. The sensors may be used to detect the environment of the image capture area. For example, a first imaging device 260 may capture a portion of an MMSM that is experiencing a vibration due to the operation of the MMSM. The vibration rate may be captured by the one or more environmental sensors 280 and be automatically associated with the images captured by the imaging device at the time of capture. The environmental sensors 280 may capture other environmental factors, such as MMSM operation speed, load, light, temperature, wind speed, humidity, and others. The data captured by environmental sensors 280 may be used to change/alter the selected ROI.

Rig control application 212 may be in electronic communication with various equipment, (e.g., valves, pumps, etc.) associated with a wellbore rig. Rig control application 212, in aspects, receives and stores information from sensors/devices associated with equipment of a drill rig and wellbore. Drill rig devices may capture and transmit information related to downhole BHA tool or rig equipment, including the depth and positional information of the drill bit, Gamma Ray readings, wellbore volume, and pump flow rate during a drilling operation, standpipe pressure, fluid density, etc.

In aspects of the technology, the wellbore model update application 290 accesses computer model variables and assumptions related to the computer modeled wellbore state. For example, predicted rock (or other object) type, color, shape, size, etc., may be accessed. In other aspects, the predicted drilling lithology, wellbore rheology, and other drill site features (e.g., the predicted wellbore state) may be accessed to determine the predicted rock (or other object) type, color, shape, size, etc. These predicted rock (or other object) types, colors, shapes, sizes, etc., may be compared with the imaged objects. It will be appreciated that the predicted rock (or other object) type, color, shape, size, etc., may change based on downhole pressure, bit depth, fluid rheology, and other operational factors.

In further aspects of the technology, the downhole monitoring application 292 uses current wellbore state and operational parameters to generate expected objects to be imaged at one or more MMSMs using the vision systems, such as vision systems 220. For example, given a measured choke pressure, hookload, flow, torque, weight-on-bit (WOB), rate of penetration (ROP), rheology, and directional sensor information, a current volume of rock cuttings may be determined. Other expected rock (or other object) type, color, shape, size, etc., may be determine. These expected rock (or other object) types, colors, shapes, sizes, etc., may be compared with the imaged objects. It will be appreciated that the expected rock (or other object) type, color, shape, size, etc., may change based on downhole pressure, bit depth, fluid rheology, and other operational factors.

The rig control application 212 and third computing device 210 may include supervisory control and data acquisition (SCADA) systems. The SCADA system is a control system architecture comprising software, computers, networked data communications, and graphical user interfaces (GUI) for high-level process supervisory management, while also comprising other peripheral devices like programmable logic controllers (PLC), decentralized control system (DCS), model predictive controller (MPC) and discrete proportional-integral-derivative (PID) controllers to interface with the managed pressure drilling (MPD) and drilling rig's equipment. The SCADA hardware may execute software that will combine data from multiple sources and perform continuous optimization of the MPD controller setpoints and tuning parameters. The model predictive controller (MPC) may be running within the SCADA software architecture or on a separate controller and using the SCADA communication architecture to get and provide updated parameters. Circulating drilling fluid may transport rock fragments out of a wellbore. The rig control application 212 may use object information obtained from image data, data acquired by an MPD data acquisition (DAQ), and rig data acquisition (DAQ) to enable the SCADA system to determine the choke pressure, hookload, flow, torque, weight-on-bit (WOB), rate of penetration (ROP), rheology, and directional sensor information. These may be used to provide feedback and control to the drilling/pumping and MPD devices as well as generate monitoring information and alerts. The rig control application 212 receive, in aspects, control requests and model updates from the wellbore stability control application 204.

As illustrated, a storage device 214 is in electronic communication with the first computing device 202, the second computing device 206, the third computing device 210 via the network 216. The storage device 214 may be used to store acquired image and computational data, as well as other data in memory and/or a database. For example, the storage device 214 may store images captured by imaging devices along with associated data, such as the time of capture. Further, sensor data and other information may be associated with the image in a relational database or other databases. The object imaging and detection application 208 may retrieve such stored data for a variety of purposes. For example, as described further herein, the object imaging and detection application 208 may set new ROIs on an image that was captured in the past. The object imaging and detection application 208 may use image data stored on the storage device 214 to retrieve the historical image and/or a portion of the historical image data, including historical image data associated with the newly set ROI. Further, the storage device may store predictive modeling information such as predicted drilling lithology, wellbore rheology, and other drill site features assumptions and/or predicted object features.

The network 216 facilitates communication between various computing devices, such as the computing devices illustrated in FIG. 2. Network 216 may be the Internet, an intranet, or another wired or wireless communication network. For example, the communication network 216 may include a Mobile Communications (GSM) network, a code division multiple access (CDMA) network. 3^{rd} Generation Partnership Project (GPP) network, an Internet Protocol (IP) network, a wireless application protocol (WAP) network, a Wi-Fi network, a satellite communications network, or an IEEE 802.11 standards network, as well as various communications thereof. Other conventional and/or later developed wired and wireless networks may also be used.

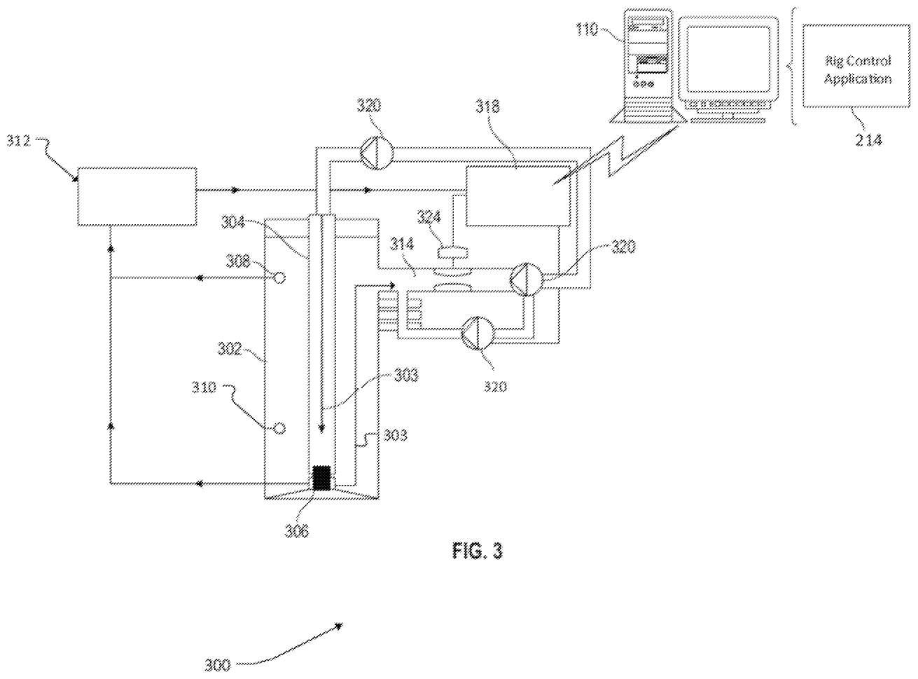

FIG. 3 is a diagram illustrating a managed pressure drilling (MPD) system 300 according to an example of the instant disclosure. FIG. 3 illustrates a wellbore 302, in which is disposed a drill pipe 304 coupled to a drill bit 306. The drill pipe 304 pumps fluid 303 down to the wellbore 302. The fluid 303 is returned via a fluid return 314. The fluid return may be a pipe, trough, etc. Various pumps 320 assist movement of the fluid 303 through the system 300, and each pump may be controlled to increase/decrease flowrate of the fluid 303 through the system 300. It will be appreciated that various MMSMs with vision systems (such as the vision systems 220 disclosed herein) may be placed along the fluid return to identify one or more objects in a flow.

In examples, the MPD controller 318 is in electronic communication with the control valve 324, a first pressure sensor 308 and a second pressure sensor 310. The valve 324 may send a signal indicating the position of the control valve 324, the first pressure sensor 308 may send a signal indicating the pressure at a top portion of the well, the second pressure signal 310 may send a signal indicating the pressure at the bottom portion of the well, and the pumps 320 may send a signal indicating the motor speed and/or flow rate through the pump. Fluid density may be tested or an in-situ sensor may be used, and these results may be sent to the MPD controller unit 318.

The MPD controller unit 318 may send various control signals to various equipment of the system 300 such as pumps 320 and the control valve 324. For example, the MPD controller unit 318 may send control signals to increase the pump speed, actuate the valve, or add more material to the fluid to increase the equivalent circulating density (ECD). In aspects, such control will change the pressure, flow rate, and/or fluid density of the fluid 303 in system 300. A monitoring system 312 may allow the display, via a computer display, for example, the various operational parameters and conditions of the wellbore. It will be appreciated that a drilling system may have more or less valves, pumps, flow sensors, and pressure sensors than those depicted in FIG. 3 without departing from the spirit of the innovative technologies.

Also illustrated is a third computing device 210 storing a Rig Control Application 212 and in electronic communication with the MPD controller 318. The Rig Control Application 212 may have the same or similar properties as those described with reference to FIG. 2, and it may be in electronic communication with the other various computing systems and applications (not shown) as described with reference to FIG. 2. For example, the Rig Control Application 212 may receive information from a wellbore stability control application and the downhole monitoring application. The Rig Control Application 212 may then translate/send that information to the MPD Controller 318 to control various operational parameters of the system 300, including fluid flow rate, pressure, and/or fluid density.

It will be appreciated that the system 300 may also include a pressure containment device, other pressure/flow control devices, a flow control device for the inlet stream, an injection line (rig pumps), a directional drilling device guiding the wellbore trajectory and weight on bit (hookload), etc., that may be controlled using the rig control application 212 and/or the MPD Controller 318.

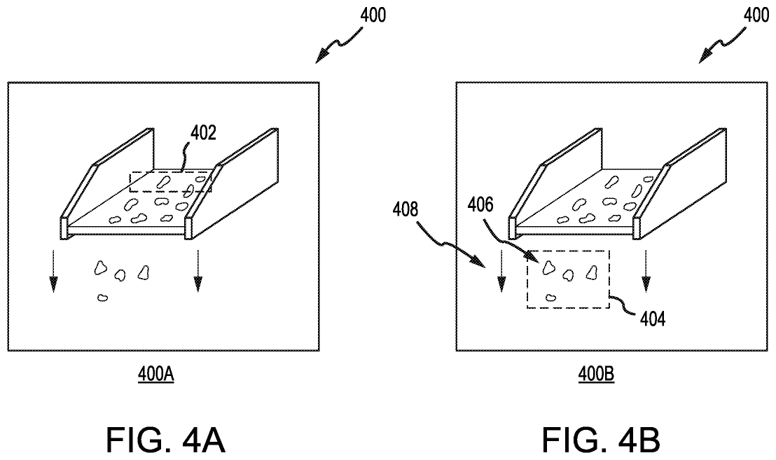

FIGS. 4A and 4B illustrate an example change in an ROI of a field of view: 400 between a first time (T1) and a second time (T2). In examples, the field of view 400 is captured by a single camera. Field of view 400 may be the entire field of view of an imaging device, which may be the same as or similar to the imaging devices described with reference to FIG. 2. FIG. 4A illustrates a first region of interest 402 in a field of view 400 at time T1, and FIG. 4B a second region of interest 404 in the field of view 400 at time T2.

In aspects of the technology, an object imaging and detection application, such as the object imaging and detection application 208 described herein, dynamically determines a new region of interest within one or more fields of view from a first-time T1 and a second, later time T2. In other examples, T2 occurs before T1. For example, where an object of interest is detected downstream, an object imaging and detection application may access historical image data that includes an upstream, earlier in time ROI. Such access may occur by the object imaging and detection application accessing a networked database on which historical image data is stored.

In aspects of the technology, the ROI 402/404 size and or shape is determined by one or more computing devices based on the direction and velocity of an object in an object flow. For example, ROI 404, which illustrates an ROI 404 including objects 406 falling in a falling zone 408 of an MMSM, may be sized and shaped such that the image captures the entirety of at least one object as it falls. In some aspects where the object is traveling at a high velocity and/or acceleration, the ROI may be vertically taller to capture the entire object in an object flow than would be needed if the object were stationary. This may occur, for example, where the imaging device was at a resolution/shutter speed that caused an object to appear longer (because of imaging distortion, e.g., streaking of the image) than would have appeared had the object been stationary.

It will further be appreciated that the field of view may be captured in real-time relative to the setting/analysis of the first ROI 402 and the second ROI 404. It will also be appreciated that the image capture may occur in the past relative to when an object imaging and detection application is setting/analyzing a region of interest. In aspects of the technology, an object imaging and detection application identifies an anomaly, such as an object of interest, and the object imaging and detection application may set a new ROI at T2. The object imaging and detection application may set the new ROI by identifying a region that may be easier to identify objects in an object flow. For example, the new ROI may be in an area of an object flow that is drier and/or slower. It will also be appreciated that the selection of a new ROI may change from one ROI to many ROIs, and from many ROIs to fewer ROIs as determined by an object imaging and detection application as further described herein.

Additionally, the settings of an imaging device may be changed to assist image capture and/or change the ROI. For example, the shutter speed, exposure, resolution, and gain may be adjusted to account for velocity, illumination level, or other conditions. Where velocity and/or illumination are higher, shutter speed may be increased to allow for a relatively smaller field of view to be used. For certain applications, a smaller ROI is desirous because, among other factors, smaller ROIs tend to need less processing time and processing power and require less network bandwidth to transmit than larger ROIs, assuming all other parameters are equal.

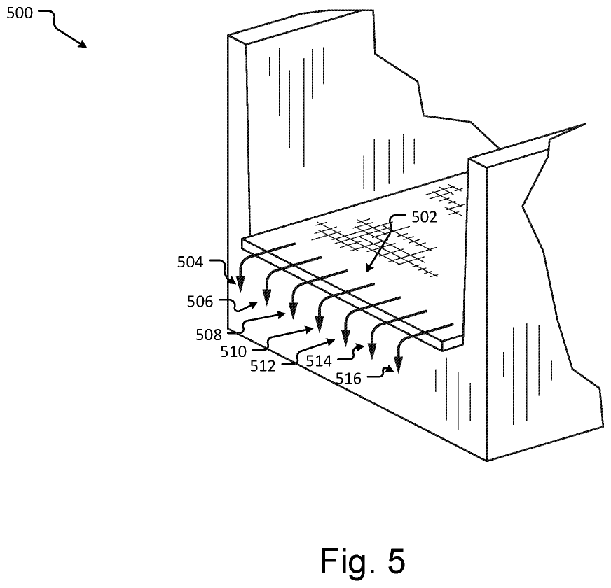

FIG. 5 is an example illustration of channels of an MMSM 500 having a screen 502. Illustrated is a first channel 504, a second channel 506, a third channel 508, a fourth channel 510, a fifth channel 512, a sixth channel 514, and a seventh channel 516. Channels are typical paths of travel of one or more objects in an object flow. These paths of travel may be influenced by the MMSM screen type, screen condition, and operation state (e.g., dirty, clean, broken, etc.). The number of channels may be preset by a user of the systems described herein. Alternatively, a DNN may automatically identify channels using training data. Objects in object flow may be aggregated by channel and displayed using the GUIs described herein.

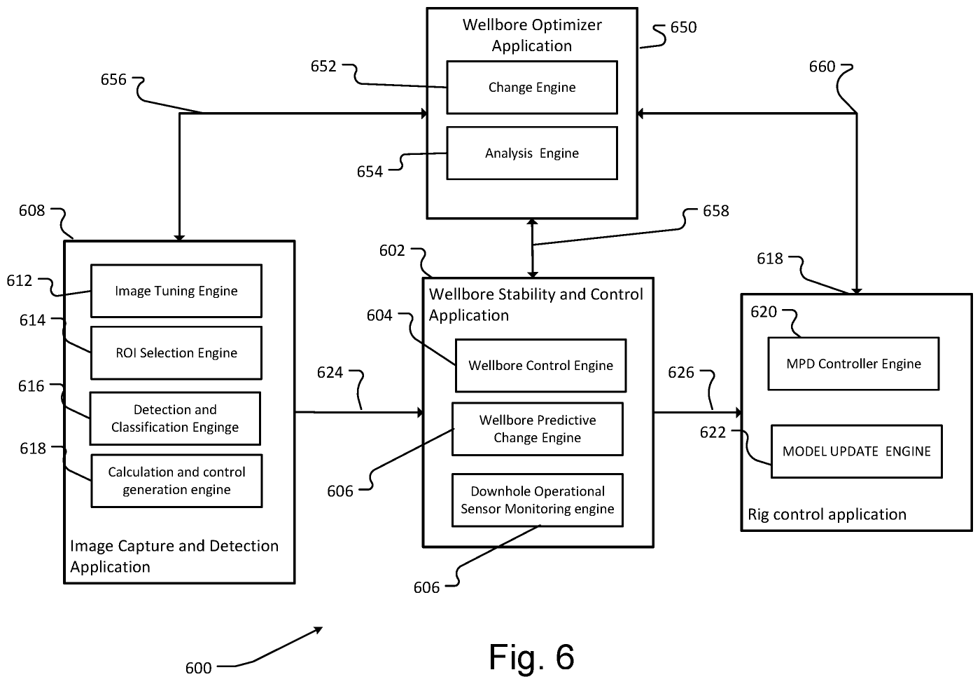

FIG. 6 illustrates example communications signals 624 and 626 between a wellbore stability and control application 602, an image capture and detection application 608, and a rig control application 618. It will be appreciated that each of these applications may be stored and executed on a single or multiple computing devices, such as the computing devices described herein.

As illustrated, the image capture and detection application 608 includes an image tuning engine 612, an ROI selection engine 614, a detection and classification and engine 616, and a calculation and control generation engine 619. In aspects of the technology, the image tuning engine 612 uses environmental factors from a drill operation when setting parameters of the one or more imaging devices. For example, the image tuning engine 612 may receive information regarding environmental factors from one or more sensors, such as environmental sensors 280, a light source 264, a drill rig sensor and/or other information. The information may be transmitted via a network. Additionally, the image tuning engine 612 may receive information that events/objects of interest are occurring at other devices, which may trigger the control system to turn on the device and/or begin capturing/storing image data. To provide specific, non-limiting examples, the amplitude and frequency signals captured by one or more sensors relating to motors (indicating motor speed, for example), flow rate detectors, or other operational indicators indicating an operating environment that may affect image capture may be used to automatically adjust various settings of one or more imaging devices and or turn on the one or more image device. Additionally, signals may be transformed into image data and analyzed by the DNN, which analysis may be output to the image tuning engine 612 to change the parameters of an imaging device.

As illustrated, image capture and detection application 608 includes an ROI selection engine 614. ROI selection engine 614 handles determining the size, shape, and location of one or more ROIs. The selected one or more ROIs are then sent to the detection and classification engine 616 for further processing as described herein. The ROI selection engine 614 may use real-time captured image data to select an ROI. Additionally/alternatively, archived/historical image data may be used to select additional ROIs.

The size, shape, and number of ROIs is determined by a variety of factors. For example, the image device settings may influence the size of the ROI. In some examples, an imaging device may be set to a low shutter speed and/or low resolution such that a greater ROI is necessary. Environmental factors, speed of or presence of object(s) in an object flow, and other data may be used to determine the size of an ROI.

Additionally, the number of ROIs within a field of view and/or the number of ROIs across multiple fields of view may be determined using information received from the detection and classification engine 614. Also, a change/additional ROI may be determined by the ROI selection engine 614 based on a number of factors, including clarity of currently selected ROI, increased/decreased objects of potential interest in a current ROI, type of object detected in a current ROI, speed/acceleration of object detected in a current ROI, and the like.

For example, where objects and or events of interest are detected, the ROI selection engine may determine to select additional ROIs for analysis. The ROI selection engine may receive information indicating that a current region of interest is in a wetter zone (e.g., screen of a shaker table) and an object captured in the wetter zone is of interest. The ROI selection engine may select additional ROIs from a different field of view (e.g., a different imaging device) or the same field of view and identify the object in a different section of the object flow. That section, for example, may be a relatively drier section, which, in examples, allows for easier classification by a detection and classification engine. If the sensor determines that an ROI is of abnormal or indicates one or more anomalous conditions (e.g., objects in object flow are too wet and/or clumpy to analyze), a new ROI may be selected, where the new ROI is selected to track an object beyond the initial ROI. For example, it may choose other ROIs at a time and place along the object flow corresponding to the likely position of the object of interest. The likely position may be determined by the estimated travel of the object moving in the object flow (e.g., based on velocity, acceleration, fluid-flow dynamics, etc.). A position may be selected based on a preferred downstream location (e.g., another MMSM) and the likely time/position of the object of interest.

ROI selection engine 614 may select an ROI to identify issues with one or more operational parameters (e.g., low flow, low/high pressure, etc.). For example, where low pressure is detected at a downhole location, additional ROIs may be selected at various MMSM to identify potential caving issues.

A detection and classification engine 616 receives image data for analysis of the image data. In aspects, the detection and classification engine preprocesses image data 616 in preparation for classification by a DNN. Image data may be an entire field of view of a camera and/or just one or more regions of interest of the field of view. In additional/alternative aspects of the technology, various environmental signals (e.g., vibration, motor electrical current, and acoustic signals) may be passed through a wavelet filter and imaged for classification. In aspects of the technology, the detection and classification engine uses a DNN to analyze the ROI to determine one or more image aspects in an ROI. The image aspects may include objects of an object flow, other objects, and/or signals that have been passed through a wavelet filter to generate an image classification by a DNN.

In aspects of the technology, DNN's are based on a series of visible and hidden layers conducting functions like convolutions to extract the features of an image. In examples, features are properties and visual characteristics of an image as identified by the neural network. In examples, the structure of the DNN includes many hidden layers built of multiple nodes that are connected to all nodes from the previous and the next layer. When training a model, the neural network is tuned by adjusting the gains (weights) used to connect all the nodes from one layer to another until the loss is at a minimal level. The loss is determined by comparing the result of the neural network with a reference like the labels of the images. In aspects, labels represent the whole image (classification) or the location and the nature of a specific region (object detection).

In examples, one or more DNN models are available for re-training (mobilenetv2, YOLO, etc. . . . ), which means the DNN is structured in a way that it knows how to efficiently extract and organize the features found in an image. These models allow, in examples, customization of the last layers where the training process tunes the connecting weights between the features extracted and how they relate to trained conditions and objects. The training algorithm may use metadata attached to the training images that have been captured or validated by a human.

In aspects of the technology, the DNN is trained using a dataset with tagged objects (e.g., cavings, cuttings (of a particular size, shape, type, etc.)). For images comprising signals transformed using a wavelet filter, the tag may include operational parameters such as evidence of failure, evidence of vibration, etc. In aspects of the technology, the training process includes a data augmentation mechanism based on spatial augmentation, color space augmentation, and image blur. Further, the deep neural network may be trained for object detection and tracking based on a custom dataset of objects potentially found on a screen shaker. In examples, the DNN may be one or more of SSD. DSSD, DetectNet_V2, FasterRCNN, YOLO V3, YOLO V4, RetinaNet. The following training model may be used based on the installation: ResNet 10/18/34/50/101, VGG16/19, GoogLeNet, MobileNetV1/V2, SqueezeNet, DarkNet, SCPDarkNet, EfficientNet.

The output from detection and classification engine 616 may be a list of identified objects, type of objects, number of objects, events (e.g., screen change out, wash cycle, excessive vibration), relative location (e.g., within various channels of a shaker table location), and/or size of the ROI. In aspects, a sub-image of each object detected is processed a second time to determine the exact contour using digital filters and correct the measured area data. A blob detection method may be used to detect regions in the zone of interest and compare those with the total area from the deep neural network. This may be used to confirm inspection performance and % hit. Static known objects or events in the field of view may be trained and part of the resulting inventory to monitor operational parameters of a rig.

Classification of objects in an object flow relates to wellbore objects in examples. It will be appreciated that a DNN may be trained to classify objects in an image in various ways. Examples include classifying objects as a cutting, a caving, a fluid, a tracer, rubble, debris, metal, plastic, rubber, etc.

In aspects of the technology, the detection and classification engine 616 may also perform unknown object detection. A DNN may return an object with low probability. Additionally, unknown objects may be detected using a combination of edge detection filters, blob detection methods, and shape detection using a deep neural network to detect an object's shape. It may also include comparisons with a total area and the list of detected objects of an object shape inventory. Unknown object images may be saved for further training. Performance indicators may be generated to warn about unknown objects being detected.

Data may be collected from various sensors, devices, and computing devices, of a rig, shaker table, etc. such as System 200 data, to augment the information coming from the detection and classification engine 616. As a non-limiting example, the number of a particular object, as classified by the detection and classification engine 616, may be aggregated and associated with a time stamp. In some instances, the object information may also be associated with environmental factors, such as the positional information of a rig. Information regarding the aggregate objects is sent from the image capture and detection application to the wellbore stability and control application 602.

In aspects of the technology, a calculation and control engine 618 tracks one or more objects in an object flow. Such tracking includes, in examples, a total number of objects over a period of time, an average rate of objects over a period of time, a rate of change of objects over a period of time, and the like. The information may be sent via the communication signal 624 to a wellbore stability and control application 602 to be used by a wellbore control engine 604 and/or a wellbore predictive change engine 606, and/or a downhole operational sensor monitoring engine 607 (which receives information from various sensors in the downhole operation, as described further with reference to FIG. 3). In aspects of the technology, the wellbore control engine 604 determines, based on the tracking, a deviation from one or more values. In aspects of the technology, the one or more values are predetermined, such as by a predictive model.

As a specific, non-limiting example, a predictive model (such as a cuttings-transport model) may set/control a drill speed, an equivalent circulating density, a pump speed, etc., as an initial matter. This may be based on assumptions determined prior to the wellbore during drilling. These assumptions may be verified/invalidated by the wellbore control engine 604 by monitoring objects in an object flow. For example, where the predictive model indicates that a certain size, shape, volume, number of cuttings, etc. should be present during drilling, the wellbore control engine 604 may compare such indication against the monitored value (using image data, for example). Where a deviation is present (e.g., where such deviation is greater than a preset value), the wellbore control engine 604 may request to control one or more drilling equipment and/or request a change to one or more drilling parameters. Additionally/alternatively, a wellbore predictive change engine 606 may request that one or more assumptions of a predictive model is updated.

In aspects of the technology, the image data may indicate that the drill may be run at a more efficient rate. For example, the image data may indicate little or no cavings, which may indicate that the drill may be run at a faster rate so as to dig the wellbore faster without sacrificing safety or wellbore integrity. In this way a “deviation” need not indicate a well failure.

In aspects of the technology, the wellbore stability and control application 602 receives information via a communication signal 624 regarding objects detected in the object flow from the image capture and detection application 608. In some aspects of the technology, the wellbore stability and control application 602 determines whether deviations from a setpoint indicate potential wellbore problems, including equipment and imaging problems. This may be accomplished using the collected data and/or predetermined set points. For example, the rate of detection of an object, change in the frequency of detection, the acceleration of change, or other metrics may be analyzed using the aggregated information of objects in an object flow collected/analyzed by image capture and detection application 608. This aggregation may be compared to a preset value by the wellbore control engine 604. The preset value may vary and/or change based on a variety of factors, including System 200 Data. When the wellbore control engine 604 determines that a deviation from one or more preset values exists, then information sufficient to control and/or communicate the deviation to the rig control application 618 may be generated and sent to the rig control application 618 via the communication channel 626.

Table I below provides example deviation identifications and example outputs that may be generated by the wellbore control engine 604. It will be appreciated that the object detected may be detected by training a DNN to recognize objects in an image at one or more MMSMs. Column 1 indicates image information detected (e.g., one or more objects detected using the systems and methods described herein) along with, optionally, one or more wellbore state identifiers, such as increased pressure. These wellbore state identifiers may be determined using one or more rig sensors as further described herein. The second column indicates an example output that may be sent (for example, electronically) to a control system of a drill rig, such as an MPD controller unit 318, and/or directly to drill equipment, such as a pump 320 and/or control valve 324.

TABLE I

| Image Information and/or Identified | |
|---|---|
| Wellbore State | Example Potential Outputs |
| Image Information includes: Low volume of | Send control signal to WOB to reduce ROP or |
| cuttings (e.g., below a threshold) detected over | cease drilling |
| a period of time | Send control signal to directional controller to |
| potentially one or more of the following | stop slide and resume rotational drilling |
| detected Wellbore States: | Send control signal to increase drilling rotary |
| pipe overpull increasing | speed |
| torque jumping (e.g., jumping beyond | Send control signal to increase flow rate (e.g., |
| predetermined threshold) | increase pump speed, open valves) |
| standpipe pressure increasing | Send signal to fluid density unit to increase |
| equivalent circulating density increasing | density |
| fluid viscosity reducing | |
| directionally sliding | |
| Hole filling up during connections when BHA | |
| resumes drilling | |
| Image Information includes: Cavings detected | Send signal to close valve to adjust the back- |
| potentially one or more of the following | pressure to change the Equivalent Circulating |
| detected Wellbore States: | Density (“ECD”) |
| pipe overpull increasing | Change direction of well e.g., by sending |
| pipe rotation torque erratic, jumping | control signal to directional controller to turn |
| standpipe pressure increasing | BHA azimuthal heading |
| equivalent circulating density decreasing | Change fluid rheology e.g., by sending signal |
| hole fill on bottom | to increase fluid density and/or ECD |
| Hole filling up during connections when BHA | Send control signal to WOB to reduce ROP or |
| resumes drilling | cease drilling |
| Blocky Caving detected potentially indicating | Send request to rig control application to |
| potential formation pre-existing fractures | change the direction of BHA |
| | Send request to rig control application to |
| | reduce valve opening |
| | Send request to rig control application to |
| | increase fluid density and/or ECD |
| Tabular Caving detected indicating potential | Send request to rig control application to |
| formation slip failure | increase fluid density and/or ECD |
| | Send request to rig control application to |
| | decrease fluid loss |
| | Send request to rig control application to |
| | reduce valve opening |
| Splintery Caving Detected indicating potential | Send request to rig control application to |
| formation tensile failure | increase fluid density and/or ECD |
| | Send request to rig control application to |
| | reduce weight on bit to slow or Cease drilling |
| Rubble Caving Detected indicating a potential | Send request to rig control application to |
| formation transition zone | reduce weight on bit to slow or cease drilling |
| | Send request to rig control application to |
| | reduce valve opening |
| | Send request to rig control application to |
| | increase fluid density |
| Low cuttings | Change drilling parameter(s) to increase hole |
| | cleaning performance by: |
| | Send request to rig control application to |
| | reduce weight on bit to slow or cease drilling |
| | Send request to rig control application to |
| | increase pump speed |
| | Adjust the back-pressure to change the |
| | Equivalent Circulating Density (“ECD”) |
| Consistent cuttings volume indicates potential | Increase ROP by; |
| to drill faster | Send request to rig control application to |
| | increase WOB |
| | Send request to rig control application to |
| | decrease fluid density |
| No Cavings (e.g., indicating potential to drill | Reduce downhole pressure by: |
| faster) | Send a request to rig control application to |
| | decrease fluid density |
| | Send request to rig control application to |
| | increase valve opening |

Additionally illustrated as part of the wellbore stability and control application 602 is wellbore model update engine 606. In aspects of the technology, wellbore model update engine 606 uses the object information received from the image capture and detection application 608 to determine one or more assumptions of a predictive model that may be different from the observed wellbore (e.g., as determined from image data). In aspects of the technology, this information may be used to update the predictive computer models. Table II below provides example image information and/or identified wellbore state and the potential updates to a predictive model that may be made. In aspects of the technology, wellbore model update engine 606 then provides that information to a rig control application 618.

TABLE II

| Image Information and/or Identified | |
|---|---|
| Wellbore State | Potential Model Changes |
| Image Information includes: Low volume of | Inform and update cuttings transport or |
| cuttings (e.g., below a threshold) detected over | drilling hydraulics model by changing one or |
| a period of time | more variables such as: |
| potentially one or more of the following | Assumed/average cutting size and |
| detected Wellbore States: | shape, |
| pipe overpull increasing | cuttings bed height (volume) |
| pipe rotation erratic | hole diameter as hole may have |
| standpipe pressure increasing | enlarged |
| equivalent circulating density increasing | change rotary speed |
| fluid viscosity reducing | fluid viscosity |
| BHA directionally sliding to turn (e.g., Hole | |
| filling up during connections when BHA | |
| resumes drilling) | |
| Image Information includes: Cavings detected | Inform and update wellbore stability or |
| potentially one or more of the following | geomechanics model of; |
| detected Wellbore States: | Formation failure type |
| pipe overpull increasing | Direction of failure type |
| pipe rotation torque erratic, jumping (e.g., | Collapse pressure |
| beyond predetermined threshold) | Inform and update cuttings transport or drilling |
| standpipe pressure increasing | hydraulics model of; |
| equivalent circulating density decreasing as | Change hole diameter |
| hole enlarges | Change cutting size to reflect larger |
| hole fill on bottom | caving size and shape |

Additionally illustrated as part of the wellbore stability and control application 602 is downhole monitor engine 624. In aspects of the technology, downhole monitor engine 624 uses the object information received from the image capture and detection application 608 and information received from downhole sensors to determine a deviation between object type (e.g., cuttings volume, flow, size, color) and what is imaged. In aspects of the technology, this information may be used to throw an alarm about possible equipment malfunction (imaging systems, downhole sensors, etc.), send a signal to halt drilling operation, and the like. Table III below provides examples of deviations between expected objects and image objects. In aspects of the technology, wellbore model update engine 624 then provides that information to a rig control application 618 to either request an update to a model and/or provide information sufficient to control operation of the rig.

TABLE III

| Deviation Detected | Potential Output |
|---|---|
| Expected: Pressure sensor | Sound alarm. |
| indicates pressure within | Query annulus pressure sensor to re-calibrate |
| parameters; expected | to known ECD and ESD |
| images should include | Query drill bit performance for bit dulling |
| normal sized cuttings at | Sound Alarm |
| current depth. Imaged: | Query downhole caliper tool to re-calibrate |
| Image data includes | Query mud weight sensor to re-calibrate to |
| objects indicative of | known mud weight and confirm ECD |
| reduced cuttings volume | Query rig lag depth calculation for deviation |
| | in time due to enlarge hole |

Rig control application 618 receives control requests and feature identification from the wellbore stability and control application 602 via a communications channel 626. In aspects of the technology, the MPD Controller Engine 620 will handle the control requests, verify whether action should be taken, and/or send a control signal to a pump, a valve, and/or a fluid-material hopper to change pump speed, actuate a valve, change hopper speed, halt operations, etc.

Additionally, the features identified may be sent to the model update engine 622. The model update engine 622 receives features and compares the identified features with the assumptive features in a predictive model. Where the feature significantly differs (e.g., greater than a setpoint) the model update engine 622 may update a predictive model. Such updates may trigger changes to the control parameters where the control parameters are based on the assumptions in the model.

FIG. 6 also illustrates a wellbore optimizer application 650 housing a change engine 652 and an analysis engine 654. The wellbore optimizer engine 650 is in two-way communication with the image capture and detection application 608 via communication pathway 656, the wellbore stability and control application 602 via communication pathway 658, and the rig control application 618 via communication pathway 660.

In aspects of the technology, the wellbore optimizer application 650 requests changes to the operational parameters and/or the predictive models related to wellbores. For example, a change engine 652 may send a request to the wellbore stability and control application 602 to change drilling parameters. This may cause, for example, the wellbore control engine 604 to change one or more drilling parameters. Additionally, the change engine 652 may request a change to one or more predictive model assumptions by requesting such change from wellbore predictive change engine 606.

In aspects of the technology, an analysis change engine 654 receives image data from image capture and detection application 608 after a change request is made. The analysis change engine 654 may determine that the change requested by the change engine 652 had no effect, and adverse effect, or a beneficial effect on the wellbore state. For example, the image data and or downhole sensors may provide data that indicate the effect of a chance. As a particular example, the change engine 654 may request for a faster drilling speed. The image data may reveal additional cuttings but no cavings or other indicia of wellbore instability. Further, downhole sensor data may indicate no wellbore stability issues (e.g., no adverse change in pressure). This may indicate a positive result, suggesting that the rig may be able to run faster without issue (e.g., a faster drill rate without comprising safety or wellbore stability). The wellbore optimizer engine application may then send a signal to the rig wellbore stability and control application and/or the rig control application 618 to keep the change permanent and/or update a drilling model. Alternatively, the change may indicate wellbore instability via the image data or downhole sensor data.

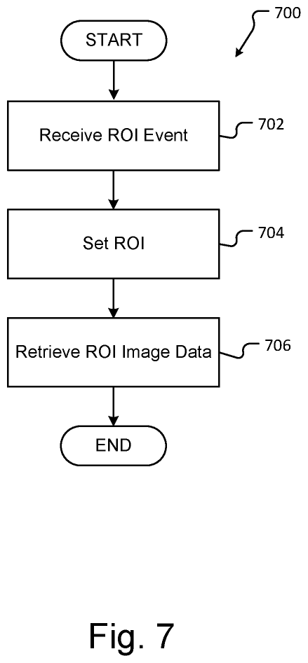

FIG. 7 illustrates a method for setting an ROI. Although the example method 700 depicts a particular sequence of operations, the sequence may be altered without departing from the scope of the present disclosure. For example, some of the operations depicted may be performed in parallel or in a different sequence that does not materially affect the function of the method 700. In other examples, different components of an example device or system that implements the method 700 may perform functions at substantially the same time or in a specific sequence. Method 700 begins with receiving ROI event operation 702. In operation 702 an ROI event is received. An ROI event is data that is received by an object imaging and detection application, such as the object imaging and detection application described above, that causes the program to set, change, remove, and/or add additional ROIs for analysis. Table IV below provides example ROI events and corresponding potential actions regarding ROIs:

TABLE IV

| Event | Action |
|---|---|
| System Initialization | ROIs set at predetermined areas such as the |
| | falling zone of MMSM |
| Potential Object of | Additional ROIs set upstream/downstream to |
| Interest Detected | analyze more/higher resolution image devices. |
| Potential failure | Increase ROI. |
| detected | |
| No deviations from norm | Change ROI number, lower resolution, |
| | and/or decrease the size of ROI. |
| Changing drilling | Adjust size, shape, and number of ROIs |
| parameters | accordingly |
| Human Activity | ROI set to increase to image maintenance |
| | activities |
| Illumination level | Shift ROI region, resolution, and/or number |
| | of ROIs |
| Audio, current, or other | Expand region of interest |
| sensor input | |
| Imaging conditions | Adjust illumination, hhods, filters, wipers, |
| suboptimal | wavelengths, vibration dampeners, shutter |
| | speed, etc. to improve image quality |

Method 700 then proceeds to retrieve ROI image data operation 706. The ROI may be applied to real-time or near real-time image data. Additionally, the ROI may be applied to historical data. In operation 706, the image data of the ROI is retrieved and sent to a detection and classification engine such as detection and classification engine described above for image detection and classification. It will be appreciated that after the method 700 ends, the method may then repeat.

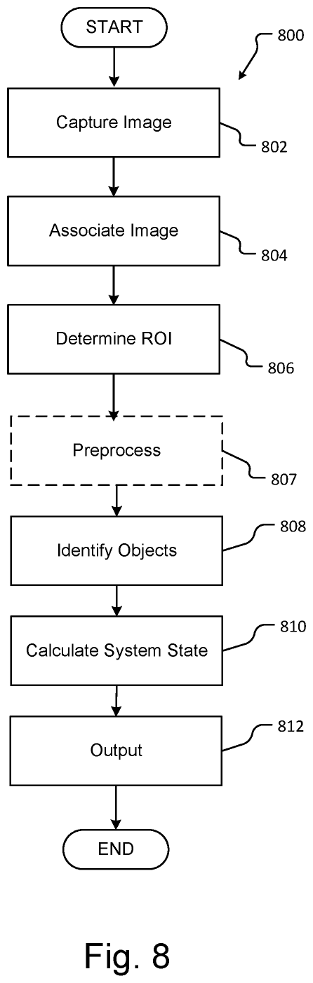

FIG. 8 is a method 800 of performing object imaging and detection of objects in one or more MMSMs by the object imaging and detection application according to an example of the instant disclosure. Although the example method 800 depicts a particular sequence of operations, the sequence may be altered without departing from the scope of the present disclosure. For example, some of the operations depicted may be performed in parallel or in a different sequence that does not materially affect the function of the method 800. In other examples, different components of an example device or system that implements the method 800 may perform functions at substantially the same time or in a specific sequence.

Method 800 begins with capture image operation 802. In operation 802, an image is captured using an image capture device, such as the imaging devices discussed herein and the imaging system 220 discussed with reference to FIG. 2. The image may also be an image formed by translating sensor information using a wavelet filter. Such signal information may include electrical current and accelerometers associated with an imaging system, such as imaging system 220.

Method 800 then proceeds to associate an image with operational parameters operation 804. In operation 804, the image may be associated with various operational parameters. For example, the time of the image capture, the positional information of the drill bit or other rig information at the time of image capture (such as for example drill rig information), the various environmental data (such as data captured by environmental sensors 280), and/or other System Data 200 may be associated with the image. The association may be stored in a database, such as in a networked storage device 214.

Method 800 then proceeds to determine ROI operation 806. In operation 806, one or more ROIs are determined. The ROI may be a portion or the entirety of a field of vision of an image captured by a vision system, such as a vision system 220. One or more imaging devices may be located such that the regions of interest include an object flow, a portion or the entirety of an MMSM, or the like, and the ROI may include a first object flow and a second object flow. A first object flow may be selected as the ROI because the first object flow is wetter than a particular threshold and the second object flow is drier than the particular threshold. As an example, a portion of the at least one region of interest may be in freefall. As another example, a portion of the at least one region of interest may capture flying objects (e.g., objects bouncing above a shaker screen). As an example, a first region of interest may trigger and/or define a second region of interest dynamically based on information analyzed in the first region of interest. For example, the ROI may be determined based on the information associated with the image or other information. Additionally, an ROI may be selected to determine the state of an MMSM. Thus, the ROI may be of a screen of a shaker or other portion of a shaker.

A particular, non-limiting example of determining an ROI is as follows. A field of view may include a screen shaker having a ledge where objects in the object flow fall off the shaker and enter free fall. The ledge may be automatically detected in the image data using the preprocessing techniques described herein and/or manually identified. Additionally/alternatively, a DNN may be used. For example, a region of interest may be selected by identifying the width of the shaker screen, a top edge, and a bottom edge. The distance from the top edge to the bottom edge may automatically be determined to ensure that at least one object in free fall is captured (e.g., the ROI is not so small as to not capture any single object). Imaging the entire width of the MMSM output may allow for total volume calculation in some applications.

In aspects of the technology, the images are captured using a video camera having a frame rate per second (FPS). The distance of the bottom edge from the top edge may be determined such that each successive frame includes all new objects but no (or few) objects are missed. This may be accomplished by identifying the time/distance it takes for an object to fall through the ROI and setting the vertical length of the ROI such that the FPS matches the time it takes for an object to fall through the falling zone. In aspects, the traveled distance is determined by the kinematic equation d=vi*t+½*a*t² where the initial vertical velocity of objects at the ledge is equal to 0 m/s and the acceleration is the gravity acceleration g=9.8 m/s².

As a particular example, where the FPS of an imaging device is 30, the vertical length of the ROI may be selected such that an object entering the falling zone (i.e., starting to fall) takes 1/30^{th} of a second to pass through the ROI. This allows, for certain applications, easier calculation of the volume of objects in an object flow because duplicate counting may be avoided.

Method 800 optionally proceeds to preprocess image operation 807. In operation 807 image data is preprocessed. In aspects of the technology, image data associated with one or more ROIs is normalized prior to sending the image data to a DNN for object detection and classification. For example, an edge of a shaker may be identified using edge detection, blob detection, or a trained DNN (or other techniques). The image may then be rotated such that image data fed to a DNN has a more uniform orientation (e.g., with the edge of a shaker table parallel to horizontal access). Additionally, the image may be white balanced, brightness equalized, and/or cropped to provide a classification DNN with a more uniform image data (e.g., one with a standard pixel size such as 256×256, 224×224, etc., one that does not have large variation in white balance, brightness equalization, etc.). Light correction may be performed. In aspects of the technology, light correction may be performed by segmenting an ROI into segments (e.g., segmenting by channels of an MMSM, which may be detected using a DNN, edge detection, or other technique). A histogram may be applied to each segment and/or channel. Other parameters such as color, bit depth, aspect ratio, etc. may be adjusted to better represent values for which the DNN has been trained. This may be done to send relatively more normalized (e.g., rotated in a particular way, light corrected) image data to a DNN, such as the DNN described herein. One advantage to preprocessing is that a DNN need not be significantly retrained for each imaging device across multiple MMSMs, rig sites, weather conditions, lighting conditions, etc.

Method 800 proceeds to identify objects operation 808. In operation 808, image analysis is applied to the one or more ROIs (as optionally preprocessed in operation 807) to detect and classify one or more objects in an image and/or one or more characteristics of a wavelet image. For example, in operation 808 at least one wellbore object is identified using the image information. Detection may occur using a DNN. Additionally, the operation 808 may further include detecting an absence of the at least one wellbore object using the image information. Additionally, the characteristics of the at least one detected wellbore object may be identified. This includes various physical properties, such as shape, volume, mass, material type, a user-defined type, or another feature that may be trained using a DNN. Further, the DNN may be trained to identify MMSM wear, such as damage to a screen, build-up on a screen, uneven table leveling, overflow of a shaker, and the like. Further, the DNN may be trained to identify objects outside of the object flow, such as the presence of a pressure washer (indicating pressure washing), a screen change out, and/or screen removal. As noted herein, the classifying may be based on machine learning and by tuning the image captured by the vision system.

Method 800 proceeds to calculate system state operation 810. In operation 810, the detected and classified objects (and/or other information) identified in operation 808 are used to calculate one or more system states. For example, the number, rate of change, and acceleration of change of objects/signals are aggregated and compared to a normal and/or setpoint. The normal and/or setpoint may automatically update based on the data associated with the image in operation 804. Additionally, the presence or absence of MMSM wear, increased frequency of events such as pressure washing, etc., may be aggregated. After comparison, one a wellbore state, including average cuttings volume, drill rig performance, the likelihood of well failure, productivity region of well, the safety level of region of well, drill bit state, MMSM state, screen state may be determined.

The method 800 then proceeds to output operation 812. In output operation 812, the number of objects, the type of objects, and/or the system state may be output to various engines or applications, such as wellbore stability and control application 602. It will be appreciated that after the method 800 ends, the method may then repeat.

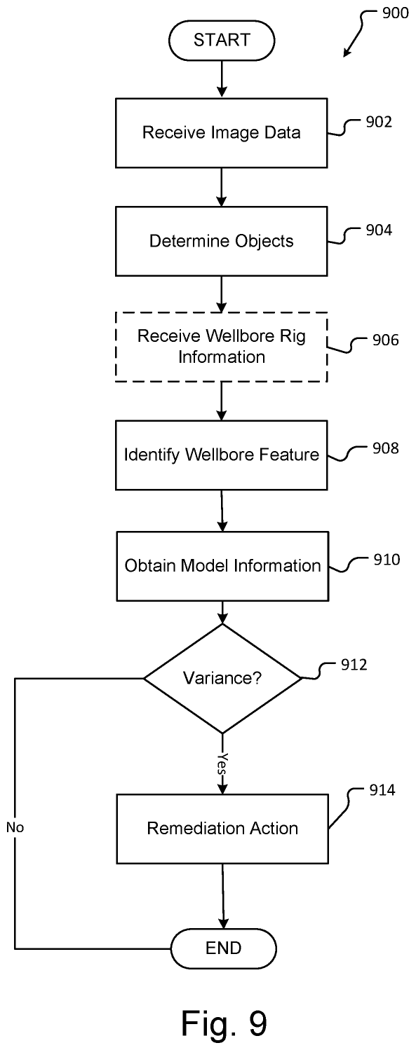

FIG. 9 is a method 900 for updating a predictive model based on received image data. Although the example method 900 depicts a particular sequence of operations, the sequence may be altered without departing from the scope of the present disclosure. For example, some of the operations depicted may be performed in parallel or in a different sequence that does not materially affect the function of the method 900. In other examples, different components of an example device or system that implements the method 900 may perform functions at substantially the same time or in a specific sequence.

Method 900 begins with receive image data operation 902. In operation 902 image data is received from one or more MMSMs. The image data may be received from a vision system, such as the vision system 220 described with reference to FIG. 2. The image data may comprise one or more ROIs, and the image data may be of images captured from a shaker table. The image data may include one or more objects in an object flow, including such objects as cuttings, cavings, and debris.

Method 900 then proceeds to determine objects in an object flow operation 904. In operation 904, various objects are analyzed (using a DNN, for example). Such analysis may be performed using the object imaging and detection application and the various associated engines as further described herein. The analysis of the image data may determine the rate at which cuttings, cavings, and other debris are flowing through one or more MMSMs. The analysis may also classify and aggregate the number of cuttings, cavings, and other debris, by material, size, shape, color, or other characteristics that may be identified using a DNN.

Method 900 then optionally proceeds to receive wellbore rig information operation 906. In operation 906, information regarding the wellbore is received. For example, a wellbore pressure, temperature, fluid flow rate, or fluid density (or other information regarding the wellbore's operating state) may be received. This information may be received from one or more sensors at a drill rig.

Method 900 then proceeds to identify wellbore feature operation 908. In identify wellbore feature operation 908, the one or more features of the wellbore are determined. This determination may be made, in aspects of the technology, based on the rate at which cuttings, cavings, and other debris are flowing through the object flow as determined by operation 904. The determination may also be made by identifying the aggregate number/volume/type of cuttings, cavings, and other debris as determined in operation 904. The determination may also be made, in aspects of the technology, by the size and shape of the cutting, cavings, and other debris flowing through the one or more MMSMs. Additionally/alternatively, the wellbore rig information operation may be used to identify wellbore feature operation 906. A feature, in examples, is the physical properties of an associated with the well, the drilling operation, and/or surrounding area, such as rock type, rock formations, bore size, porosity, permeability, cuttings and cavings presence (including type, amount, size, shape, color, etc.), wellbore trajectory, lithology, saturation, pressure and temperature, formation strength, etc.

Method 900 then proceeds to obtain model information operation 910. In operation 910, model information regarding a predictive model is obtained. In aspects of the technology, the information may be obtained by sending a request to another computing device, server, or cloud-based service. In other aspects, the information is obtained by accessing computer memory. The predictive model information may include one or more of cuttings transport model, drilling hydraulics, mechanical earth, wellbore stability, and geomechanics information.

Method 900 then proceeds to determination 912. In determination 912, the wellbore feature identified in operation 908 is compared to the model information obtained in operation 910. If the model information varies from the ascertained feature identified in operation 908, a remediation action 914 may be taken. Such remediation action may include updating the model with the wellbore feature, acquiring more image data (e.g., by selecting additional ROIs for additional analysis), sending an alert, etc. If no variance (or no variance beyond a threshold) is detected, then the method ends. It will be appreciated that after the method 900 ends, the method may then repeat.

As a particular example, carrying capacity may be determined using the captured image data. In particular, carrying capacity of a fluid is determined in part by the cuttings shape/size. Many models assume a spherical shape of the objects to be carried. When non-spherical shapes are detected, the cuttings transport model may be updated to account for the non-spherical shape. In examples, non-spherical shapes increase drag of the objects flowing in the object flow (e.g., caving types or cuttings grinding). This may result, for example, if the carrying capacity being reduced. Other changes may be identified, such as the changes described in Table II.

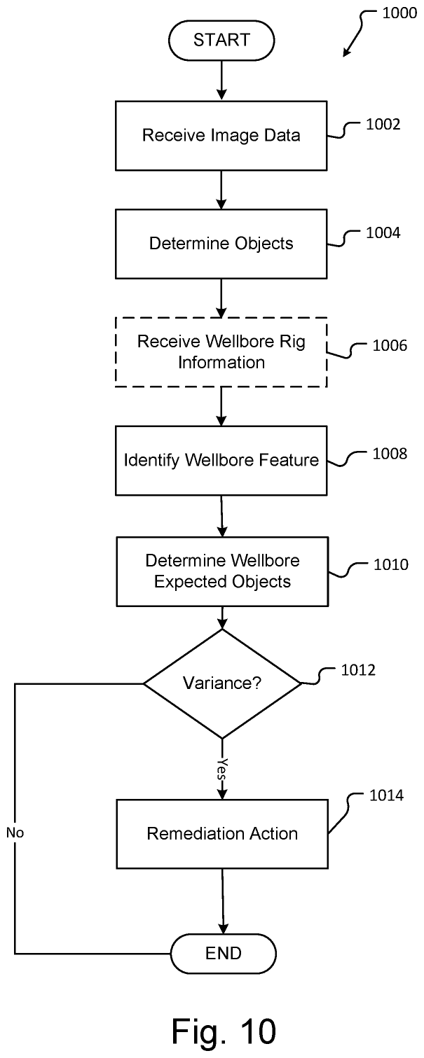

FIG. 10 is a method 1000 for identifying a variance between expected image data based on downhole sensors and other operational parameters and detected objects. Although the example method 1000 depicts a particular sequence of operations, the sequence may be altered without departing from the scope of the present disclosure. For example, some of the operations depicted may be performed in parallel or in a different sequence that does not materially affect the function of the method 1000. In other examples, different components of an example device or system that implements the method 1000 may perform functions at substantially the same time or in a specific sequence.

Method 1000 begins with receive image data operation 1002. In operation 1002 image data is received from one or more MMSMs. The image data may be received from a vision system, such as the vision system 220 described with reference to FIG. 2. The image data may comprise one or more ROIs, and the image data may be of images captured from a shaker table. The image data may include one or more objects in an object flow, including such objects as cuttings, cavings, and debris.

Method 1000 then proceeds to determine objects in an object flow operation 1004. In operation 1004, various objects are analyzed (using a DNN, for example). Such analysis may be performed using the object imaging and detection application and the various associated engines as further described herein. The analysis of the image data may determine the rate at which cuttings, cavings, and other debris are flowing through one or more MMSMs. The analysis may also classify and aggregate the number of cuttings, cavings, and other debris, by material, size, shape, color, or other characteristics that may be identified using a DNN.

Method 1000 then proceeds to receive wellbore rig information operation 1006. In operation 1006, information regarding the wellbore is received. For example, a wellbore pressure, temperature, fluid flow rate, or fluid density may be received. This information may be received from one or more sensors at a drill rig.

Method 1000 then proceeds to identify wellbore feature operation 1008. In identify wellbore feature operation 1008, the one or more features of the wellbore are determined. This determination may be made, in aspects of the technology, based on the rate at which cuttings, cavings, and other debris are flowing through the object flow as determined by operation 1004. The determination may also be made by identifying the aggregate number/volume/type of cuttings, cavings, and other debris as determined in operation 1004. The determination may also be made, in aspects of the technology, by the size and shape of the cutting, cavings, and other debris flowing through the one or more MMSMs. Additionally/alternatively, the wellbore rig information operation may be used to identify wellbore feature operation 1006.

Method 1000 then proceeds to determine expected object operation 1010. In operation 1010, the downhole sensor and other operational information (choke pressure, hookload, flow, torque, weight-on-bit (WOB), rate of penetration (ROP), rheology, and directional sensor information, a current volume of rock cuttings) is used to determine a likely object type at one or more MMSMs. For example, at a certain depth, it may be expected that a volume of cuttings of having a certain average size is expected. It will be appreciated that the lag time between rock cuttings and detection at one or more MMSMs may be determined based on flow rate, bit depth, casing length, and other factors. The result is an expected object type profile.

Method 1000 then proceeds to determination 1012. In determination 1012, the wellbore feature identified in operation 1008 is compared to the expected object type profile determined in operation 1010. If the model information varies from the ascertained feature identified in operation 1008, a remediation action 1014 may be taken. Such remediation action may include acquiring more image data (e.g., by selecting additional ROIs for additional analysis), sending an alert, etc. If no variance (or no variance beyond a threshold) is detected, then the method ends. It will be appreciated that after the method 1000 ends, the method may then repeat.

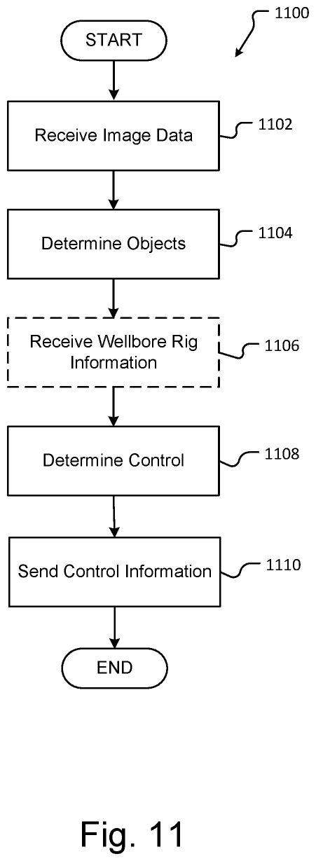

FIG. 11 is a method 1100 for controlling one or more rig parameters based on received image data. Although the example method 1100 depicts a particular sequence of operations, the sequence may be altered without departing from the scope of the present disclosure. For example, some of the operations depicted may be performed in parallel or in a different sequence that does not materially affect the function of the method 1100. In other examples, different components of an example device or system that implements the method 1100 may perform functions at substantially the same time or in a specific sequence.

Method 1100 begins with receive image data operation 1102. In operation 1102 image data is received from one or more MMSMs. The image data may be received from a vision system, such as the vision system 220 described with reference to FIG. 2. The image data may comprise one or more ROIs, and the image data may be of images captured from a shaker table. The image data may include one or more objects in an object flow, including such objects as cuttings, cavings, and debris.

Method 1100 then proceeds to determine objects in an object flow operation 1104. In operation 1104, various objects are analyzed (using a DNN, for example). Such analysis may be performed using the object imaging and detection application and the various associated engines as further described herein. The analysis of the image data may determine the rate at which cuttings, cavings, and other debris are flowing through one or more MMSMs. The analysis may also classify the cuttings, cavings, and other debris, by material, size, shape, color, or other characteristics that may be identified using a DNN.

Method 1100 then optionally proceeds to receive wellbore rig information operation 1106. In operation 1106, information regarding the wellbore is received. For example a wellbore pressure, temperature, fluid flow rate, or fluid density may be received. This information may be received from one or more sensors at a drill rig.

Method 1100 then proceeds to determine action operation 1108. In determine wellbore action operation 1108, the method determines one or more action to take based on the conditions of the wellbore. This determination may be made, in aspects of the technology, based on the rate at which cuttings, cavings, and other debris are flowing through the object flow. The determination may also be made by identifying the aggregate number/volume/type of cuttings, cavings, and other debris. The determination may also be made, in aspects of the technology, by the size and shape of the cutting, cavings, and other debris flowing through the one or more MMSMs. Additionally/alternatively, the wellbore rig information operation may be used to make the determination. Table one provides examples of actions that may be determined based on the conditions identified in operation 604 and/or 606.

Method 1100 then proceeds to send control information operation 1110. In operation 1110, control information is sent to a controller and/or an application, such as the rig control applications described herein. The information may be information that a caving is detected along with a recommended action. In alternative/additional examples, the information may be a signal that directly instructs the rig control application to send control signals to actuate valves, add material to fluid, increase/decrease fluid pump speed, etc. It will be appreciated that after the method 1100 ends, the method may then repeat.

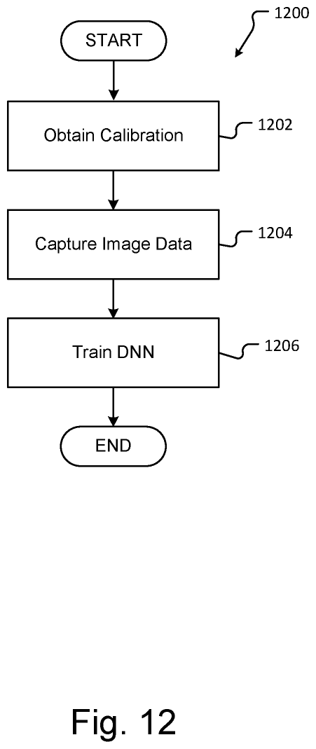

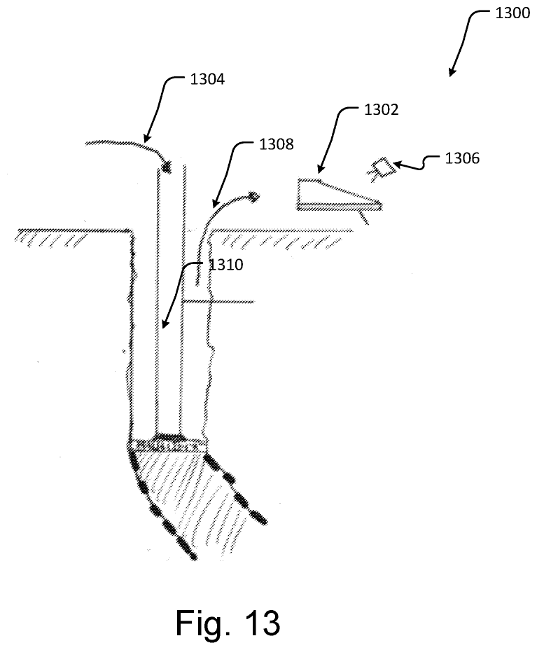

FIG. 12 illustrates a method 1200 of measuring the volume and/or mass of a shaker load coming across the shaker using a vision system. FIG. 12 is discussed with respect to FIG. 13, which is an example well environment 1300 having an MMSM 1302 and a vision system 1306 in electronic communication with an object imaging and detection engine (not shown). It will be appreciated that vision system 1306 may have the same or similar properties as the vision systems discussed above and the object imaging detection engine has the same or similar properties as discussed above.

Method 1200 begins with obtaining calibration operation 1202. To obtain calibration operation 1202 a known volume/mass of cuttings and or object flow is obtained. Known volume/mass may be obtained in a variety of ways. A cuttings volume meter (CVM) may be used to identify the volume/mass of cuttings, fluids, and other objects coming off of the shaker table. Additionally/alternatively, the object flow of a shaker table may be collected into a container of known volume. The container may be weighed, and the constituent parts of the flow may be separated to determine the volume and mass of cuttings, cavings, liquids, and other objects in an object flow 1408. Operation 1202 may be repeated numerous times for object flow with various liquid to solid content, liquid densities, number of objects, etc. The result of operation 1202 is a mass/volume of cuttings, cavings, drilling fluid, and or other objects in the object flow.

Calibration may also occur by drilling a well of known volume and tracking that volume through the system. For example, a well hole 1310 as shown in FIG. 13 may be formed by removing a certain volume and mass of rock. Drilling fluid 1304 displaces the drilling cuttings and other debris, causing the objects to flow up the wellhole in an object flow 1308 to be processed by one or more MMSMs 1302. In this way, the volume/mass of cuttings and rock removed may be known and/or estimated. In aspects of the technology, the fluid 1304 includes a tracer, or metal and rubber float equipment that is easily identifiable by vision system 1306.

Method 1200 also includes capture image data 1204 operation. In operation 1204, an image/video of the MMSM 1302 is captured during operation 1204 using vision system 1306. In the case of calibration by drilling a well of known volume, the captured image may be associated with the object flow 1308 by identifying the tracer liquid such that all flow of objects from the wellbore is captured.

Method 1200 proceeds to train DNN 1206. A DNN may be trained using the calibration data captured in operation 1202 and associated with the image data captured at operation 1204. This results in a trained DNN such that images of object flows at various ROIs may be analyzed by a DNN and a cuttings volume, cuttings mass, liquid volume, liquid mass, and/or other objects may be estimated using the image data.

Once calibrated, image data may be used to identify potential issues with drilling. For example, drilling while drilling the hole may become enlarged to a size larger than the drilling bit diameter due to vibration, wellbore instability, and excessive flow rates. These enlarged zones may be referred to as washouts and cause significant problems with hole cleaning. Conversely, the hole may become reduced if the formation swells creating restrictions for the BHA. Once calibrated, image data may be used to identify object flow that indicates a greater or smaller than usual for the expected drill hole size. It will be appreciated that after the method 1200 ends, the method may then repeat.

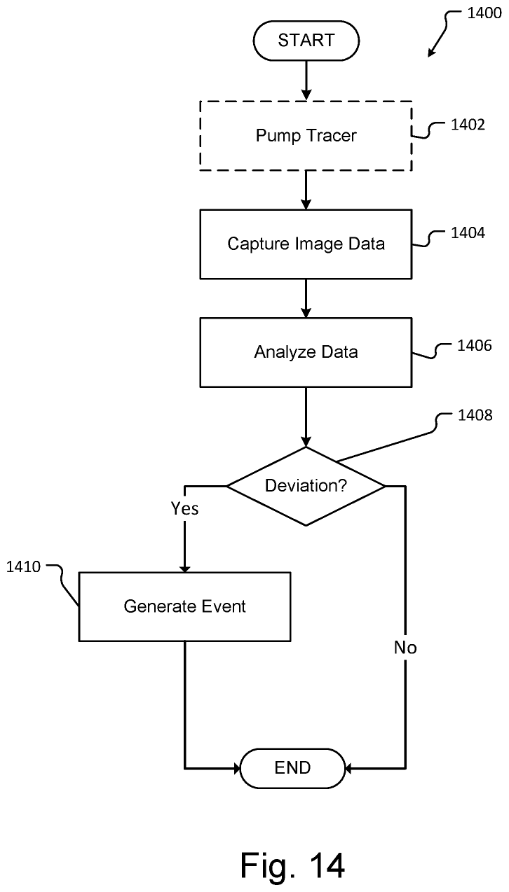

FIG. 14 is a method 1400 to determine a deviation from a computer model and/or expected images from actually image data. Method 1400 optionally begins with a pump tracer into well operation 1402. In some aspects of the technology, the tracer may be easily identified by a vision system and an object imaging and detection engine because of variant contrast.

Method 1400 then proceeds to capture traced object flow operation 1404. In operation 1404, the object flow with, in some aspects, a tracer is captured using a vision system, such as the vision system described herein.

Method 1400 then proceeds to analyze image data operation 1406. In operation 1406, the image data, which may include cutting size, shape, and sphericity, are analyzed to determine the volume of cuttings, liquid, cavings, etc.

Method 1400 then proceeds to determine deviation 1408. In determination 1408, it is determined whether a deviation exist between the analyzed data of operation 1406 and computer modeled image data and/or expected image data (e.g., as expected given current operation parameters of the rig such as downhole pressure, bit depth, weight on bit, etc.).

If a deviation exits, an event is generated at operation 1410. For example, a control signal may be generated to control the well, a shutdown request may be initiated, an alarm may be generated, a request to update the computer model may be generated, and the like. After operation 1410, or if no deviation exists, method 1400 ends. It will be appreciated that after the method 1400 ends, the method may then repeat.

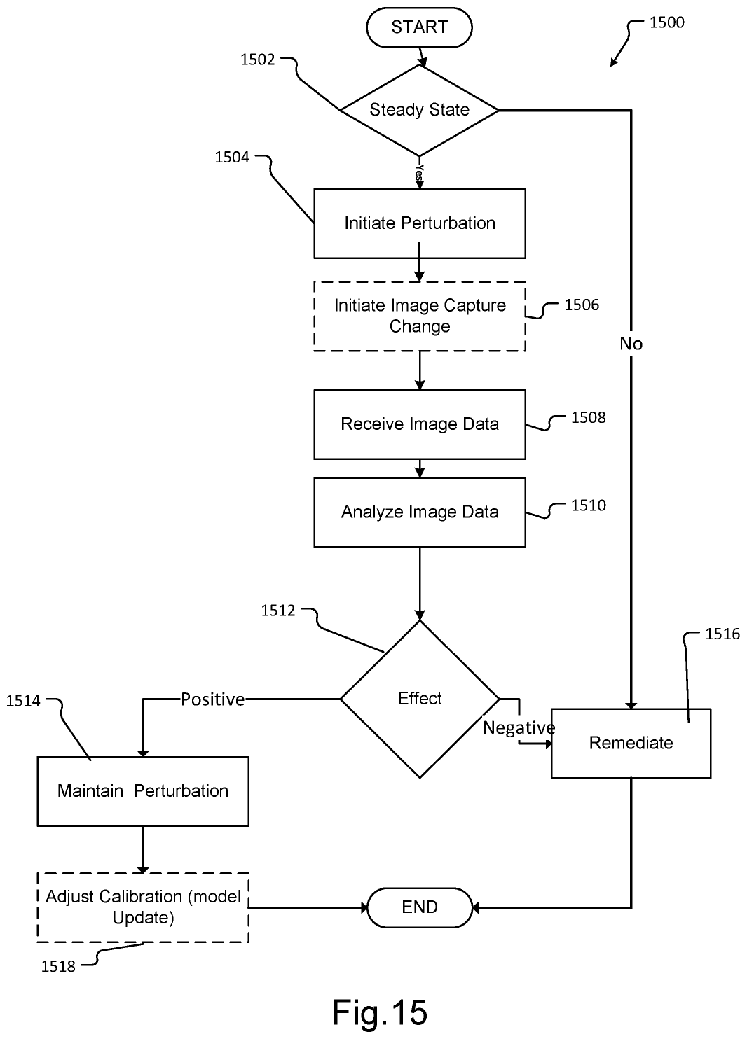

FIG. 15 is a method 1500 of optimizing a wellbore through directed changes. Method 1500 beings with steady state determination 1502. In determination 1502, it is determined whether a steady state of the wellbore has been reached. A steady state may be indicated by image data indicating that the imaged objects in object flow match the expected objects (e.g., as determined by estimating objects using operational parameters such as weight on bit, fluid density, flow rate, bit speed) and/or model predicted objects (e.g., as predicted by computer models in conjunction with operational parameters). In additional/alternative aspects of the technology, a determination may be made using image data to determine that objects in an object flow indicate proper wellbore formation and no wellbore instability. For example, steady images of cuttings at an expected frequency, volume, size, and color may indicate a steady state condition. Where the determination is yes, the method proceeds to initiate perturbation operation 1504. Where the determination is no (indicating a potential issue wellbore issue, the method 1500 flows to remediate operation 1512.

Perturbation operation 1504 may be performed by one or more of the engines/applications described above, such as change engine 652. In operation 1504, a computing system initiates a perturbation (e.g., a change from current setpoint) of one or more operational parameters and/or predictive computer model assumptions/variables. This may include changing one of a pump speed, drill speed, weight on bit, fluid density, valve openness, etc.

In aspects of the technology, the perturbation may be calculated to yield a corresponding volume increase/decrease of objects (such as cuttings) within a known timeframe. For example, an increase in the Rate of Penetration may be calculated to yield a certain amount of increased cuttings, object flow, etc., during a certain amount of time given certain operational parameters (e.g., drill depth, weight on bit, fluid density, fluid flow rate). As such, the perturbation may be determined to cause such an increase. Other changes are contemplated, such as drill speed, fluid flow rate, lithology assumptions, etc. Changes to operational parameters and/or models may be calculated to cause an expected increase/decrease in the objects/object flow imaged at one or more MMSMs such as aggregate volume, cutting size, cuttings shape, cuttings size, etc. It will be obvious to one skilled in the art that the above situation may be reversed—e.g. if the wellbore operation is observed to not be smooth, the perturbation could be to slow the drilling rate.

Method 1500 then optionally proceeds to initiate image capture operation 1506. In operation 1506, an image capture operation is initiated. For example, a change to the number of ROIs, image capture rate, shutter speed of an imaging device, lighting at an image capture area, and number of imaging devices capturing images, etc., may occur. In examples, the changes to image capture correspond to capturing more data to capture image data reflecting the impact of the change initiated at operation 1504. Changes may be initiated by sending a request from a wellbore optimizer application 650 via the change engine 652 to the image capture and detection application 608 (e.g., an image tuning engine 612 may make changes to vision systems as discussed herein).

Method 1500 then proceeds to receive image data operation 1508. In operation 1508, image data is received. Image data may be received from one or more image devices via one or more ROIs. The image data may include the falling zone of an MMSM. In aspects of the technology, the image data is processed to identify aggregate objects in an object flow along with various classifications of such objects.

Method 1500 then proceeds to analyze image data operation 1510. In operation 1510, the image data received at 1510 is analyzed to determine whether the change initiated at operation 1504 had an effect. In aspects of the technology, it may be determined that the change had a positive effect (e.g., the ROP of the drill increased without sufficient indicia of wellbore instability as indicated by the image data). In other aspects of the technology, it may be determined that the change had a negative effect (e.g., the change caused the presence of cavings.) or no effect (negative). Where a change is expected but no change is detected, this may indicate a problem one or more of the predicted models, the expected images, the visions system, and/or the operational devices/measurements.

Method 1500 then proceeds to decision 1512. If a positive change is detected, the method 1500 proceeds to maintain perturbation operation 1514 where the change is maintained for at least a set period of time after. If the change is detected as negative, operation 1500 proceeds to remediate action 1516, where the change may be reverted and other remediation action occurs. In examples, where no effect is detected and no effect is considered negative, the method then proceeds to remediate action operation 1516 where the settings are reverted.

Operation 1516 remediates issues with drilling operation. For example, the drilling may be stopped, the weight on bit may be changed, the drill speed may be changed or halted, the fluid density may be adjusted, and fluid flow rate may change. Where the negative effect was determined based on a perturbation, the settings may revert back to the previous settings.

After operation 1514, the method 1500 may optionally proceed to adjust calibration model (e.g., change cuttings flow transport model) 1518. In adjust calibration model, one or more predictive models may change.

It will be appreciated that after the method 1500 ends, the method may then repeat with the same, similar, or different changes initiated. It will be further appreciated that the results of the perturbation analysis may be used to determine various aspects of the current wellbore state as indicated by Table V below.

Table V below indicates potential system perturbation, image data, and probably wellbore state indications.

TABLE V

| | Image Data | Probable wellbore state |
|---|---|---|
| Perturbation | Results | conditions |
| bit speed and weight | No corresponding | bit is wearing out |
| on bit is increased | increase in | |
| | volume | |
| Inc ROP, more | Less cuttings | Poor hole cleaning as |
| cuttings | | calculated hydraulic |
| | | parameter insufficient |
| | | Hole over gauge |
| Inc/Dec RPM, more | Less/same | Poor hole cleaning as |
| cuttings/less | | calculated hydraulic |
| | | parameter insufficient |
| | | Reducing RPM with same |
| | | cuttings removal reduces |
| | | equipment wear |
| | | Directionally drilling in |
| | | slide mode will reduce |
| | | cuttings recovery |
| Inc/Dec Flow rate, | Less/same | Poor hole cleaning as |
| more/less cuttings | | calculated hydraulic |
| | | parameter insufficient |
| | | Reducing GPM with same |
| | | cuttings removal reduces |
| | | equipment wear |
| Bypass prescribed | cavings | In an effort to drill deeper |
| changes, no cavings | | before setting casing, the |
| | | mud weight is not |
| | | increased even though its |
| | | planned. If they are lucky |
| | | the formation does not |
| | | become unstable, if they |
| | | are unlucky cavings show |
| Decrease mud weight, | cavings | In an effort to drill faster or |
| no cavings | | discover the formation |
| | | pressure, the mud weight is |
| | | reduced or MPD choke |
| | | pressure is reduced, when |
| | | cavings are seen the well is |
| | | unstable. |

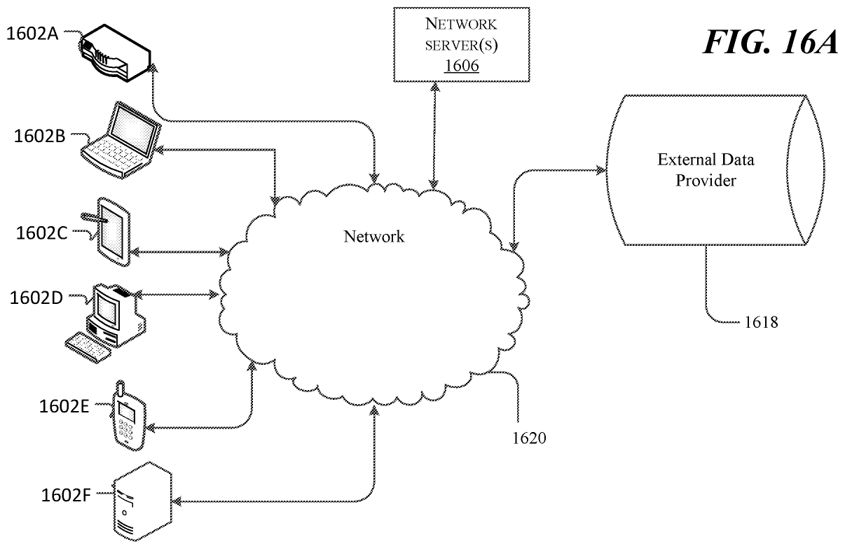

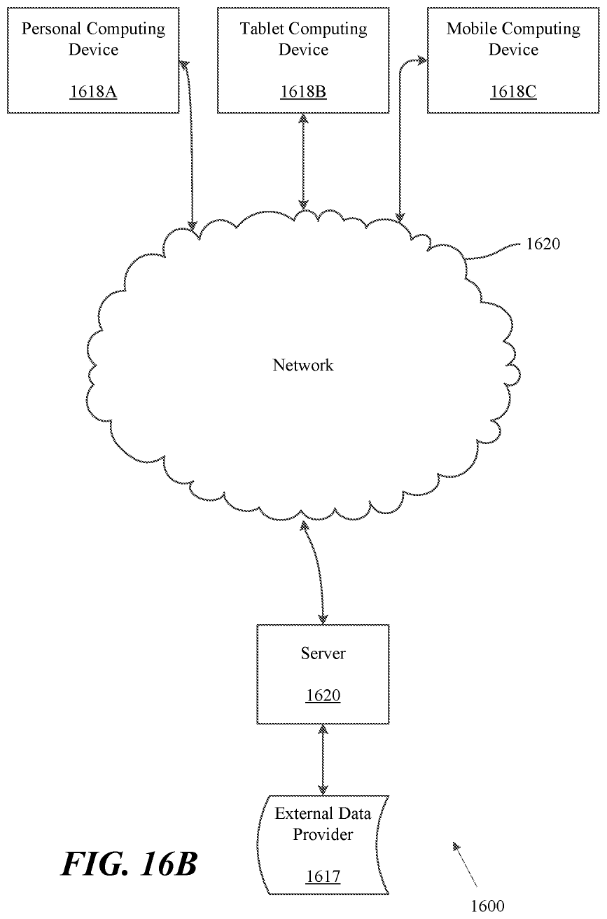

FIG. 16A is an example diagram of a distributed computing system 1600 in which aspects of the present innovative technology, including the object imaging and detection engine described above, may be implemented. According to examples, any computing devices, such as a modem 1602A, a laptop computer 1602B, a tablet 1602C, a personal computer 1602D, a smartphone 1602E, and a server 1602F, may contain engines, components, engines, etc. for controlling the various equipment associated with image capture and detection. Additionally, according to aspects discussed herein, any of the computing devices may contain the necessary hardware for implementing aspects of the disclosure. Any and/or all of these functions may be performed, by way of example, at network servers and/or server when computing devices request or receive data from external data providers by way of a network 1620.

Turning to FIG. 16B, one embodiment of the architecture of a system for performing the technology discussed herein is presented. Content and/or data interacted with, requested, and/or edited in association with one or computing devices may be stored in different communication channels or other storage types. For example, data may be stored using a directory service, a web portal, a mailbox service, an instant messaging store, or a compiled networking service for image detection and classification. The distributed computing system 1600 may be used for running the various engines to perform image capture and detection, such as those discussed herein. The computing devices 1618A. 1618B, and/or 1618C may provide a request to a cloud/network 1620, which is then processed by a network server 1606 in communication with an external data provider 1617. By way of example, a client computing device may be implemented as any of the systems described herein and embodied in the personal computing device 1618A, the tablet computing device 1618B, and/or the mobile computing device 1618C (e.g., a smartphone). Any of these aspects of the systems described herein may obtain content from the external data provider 1617.

In various examples, the types of networks used for communication between the computing devices that make up the present invention include but are not limited to, the Internet, an intranet, wide area networks (WAN), local area networks (LAN), virtual private networks (VPN). GPS devices, SONAR devices, cellular networks, and additional satellite-based data providers such as the Iridium satellite constellation which provides voice and data coverage to satellite phones, pagers, and integrated transceivers, etc. According to aspects of the present disclosure, the networks may include an enterprise network and a network through which a client computing device may access an enterprise network. According to additional aspects, a client network is a separate network accessing an enterprise network through externally available entry points, such as a gateway, a remote access protocol, or a public or private Internet address.

Additionally, the logical operations may be implemented as algorithms in software, firmware, analog/digital circuitry, and/or any combination thereof, without deviating from the scope of the present disclosure. The software, firmware, or similar sequence of computer instructions may be encoded and stored upon a computer-readable storage medium. The software, firmware, or similar sequence of computer instructions may also be encoded within a carrier-wave signal for transmission between computing devices.

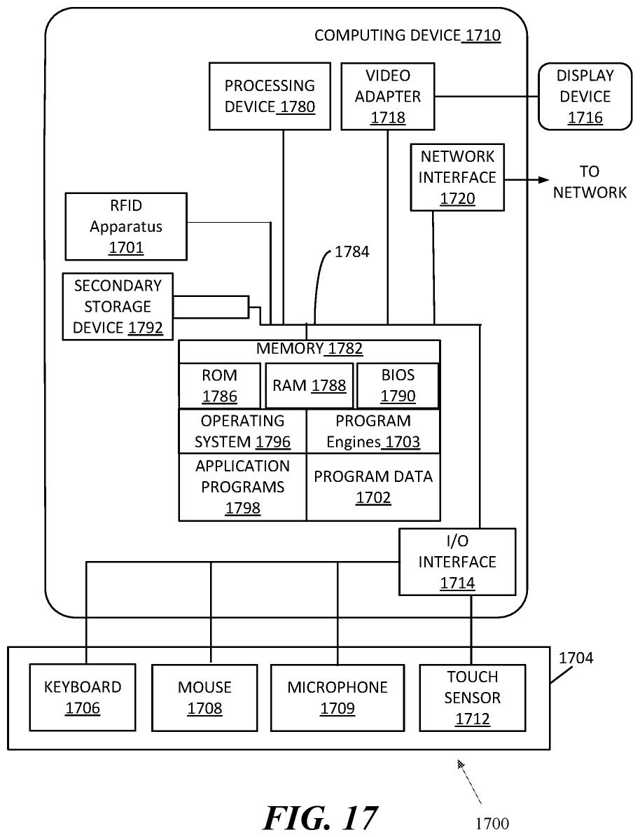

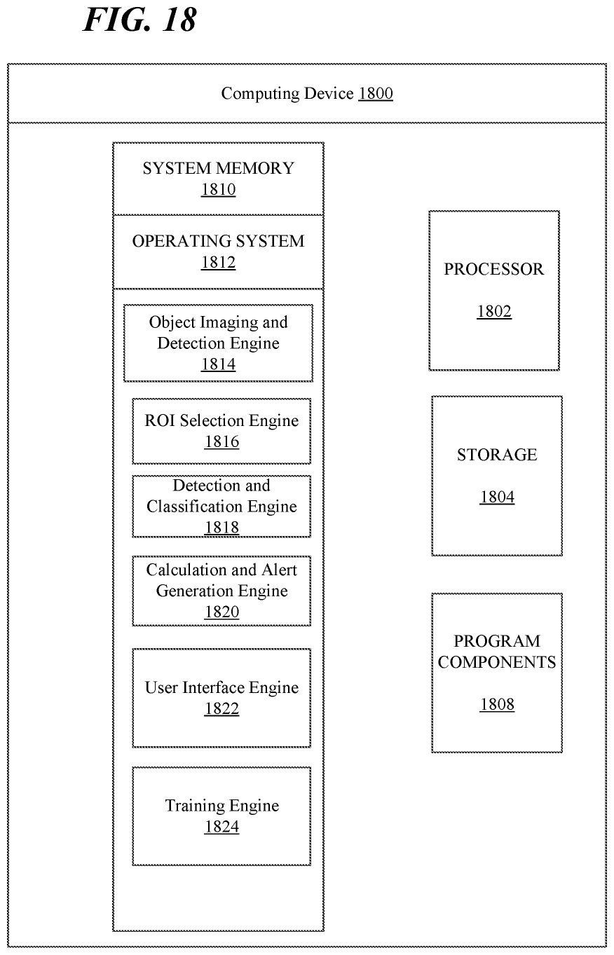

FIG. 17 illustrates an example operating environment 1700, which typically includes at least some form of computer-readable media. Computer-readable media may be any available media that may be accessed by a processor such as processing device 1780 depicted in FIG. 17 and processor 1802 shown in FIG. 18 or other devices comprising the operating environment 1700. By way of example, and not limitation, computer-readable media may comprise computer storage media and communication media. Computer storage media includes volatile and nonvolatile, and removable and non-removable media implemented in any method or technology for storage of information such as computer-readable instructions, data structures, program engines, or other data. Computer storage media includes RAM, ROM, EEPROM, flash memory or other memory technology, CD-ROM, digital versatile disks (DVD) or other optical storage, magnetic cassettes, magnetic tape, magnetic disk storage or other magnetic storage devices, or any other non-transitory medium which may be used to store the desired information. Computer storage media does not include communication media.

Communication media embodies computer-readable instructions, data structures, program engines, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media.

The operating environment 1700 may be a single computer operating in a networked environment using logical connections to one or more remote computers. The remote computer may be a personal computer, a GPS device, a monitoring device such as a static-monitoring device or a mobile monitoring device, a pod, a mobile deployment device, a server, a router, a network PC, a peer device, or other common network nodes, and typically includes many or all of the elements described above as well as others not so mentioned. The logical connections may include any method supported by available communications media. Such networking environments are commonplace in enterprise-wide computer networks, intranets, and the Internet.

Computing system 1700 may be used to implement aspects of the present disclosure, including any of the plurality of computing devices described herein with reference to the various figures and their corresponding descriptions. The computing device 1800 illustrated in FIG. 18 may be used to execute an operating system 1796, application programs 1798, and program engines 1703 such as the engines described herein.

The computing device 1710 includes, in some embodiments, at least one processing device 1780, such as a central processing unit (CPU). A variety of processing devices are available from a variety of manufacturers, for example, Intel, Advanced Micro Devices, and/or ARM microprocessors. In this example, the computing device 1710 also includes a system memory 1782, and a system bus 1784 that couples various system components including the system memory 1782 to the at least one processing device 1780. The system bus 1784 is one of any number of types of bus structures including a memory bus, or memory controller; a peripheral bus; and a local bus using any of a variety of bus architectures.

Examples of devices suitable for the computing device 1710 include a server computer, a pod, a mobile-monitoring device, a mobile deployment device, a static-monitoring device, a desktop computer, a laptop computer, a tablet computer, a mobile computing device (such as a smartphone, an iPod® or iPad® mobile digital device, or other mobile devices), or other devices configured to process digital instructions.

Although the exemplary environment described herein employs a hard disk drive or a solid state drive as a secondary storage device, other types of computer-readable storage media are used in other aspects according to the disclosure. Examples of these other types of computer-readable storage media include magnetic cassettes, flash memory cards, digital video disks. Bernoulli cartridges, compact disc read-only memories, digital versatile disk read-only memories, random access memories, or read-only memories. Additional aspects may include non-transitory media. Additionally, such computer-readable storage media may include local storage or cloud-based storage.

A number of program engines may be stored in the secondary storage device 1792 or the memory 1782, including an operating system 1796, one or more application programs 1798, other program engines 1703 (such as the software engines described herein), and program data 1702. The computing device 1710 may utilize any suitable operating system, such as Linux, Microsoft Windows™, Google Chrome™, Apple OS, and any other operating system suitable for a computing device.

According to examples, a user provides inputs to the computing device 1710 through one or more input devices 1704. Examples of input devices 1704 include a key board 1706, a mouse 1708, a microphone 1709, and a touch sensor 1712 (such as a touchpad or touch-sensitive display). Additional examples may include input devices other than those specified by the keyboard 1706, the mouse 1708, the microphone 1709, and the touch sensor 1712. The input devices are often connected to the processing device 1780 through an input/output (I/O) interface 1714 that is coupled to the system bus 1784. These input devices 1704 may be connected by any number of I/O interfaces 1714, such as a parallel port, serial port, game port, or universal serial bus. Wireless communication between input devices 1604 and the interface 1714 is possible as well and includes infrared. BLUETOOTH® wireless technology, cellular, and other radio frequency communication systems in some possible aspects.

In an exemplary aspect, a display device 1716, such as a monitor, liquid crystal display device, projector, or touch-sensitive display device, is also connected to the computing system 1710 via an interface, such as a video adapter 1718. In addition to the display device 1716, the computing device 1710 may include various other peripheral devices, such as speakers or a printer.

When used in a local area networking environment or a wide area networking environment (such as the Internet), the computing device 1710 is typically connected to a network such as network 1520 shown in FIGS. 16A and 16B through a network interface, such as an Ethernet interface. Other possible embodiments use other communication devices. For example, certain aspects of the computing device 1710 may include a modem for communicating across the network. The computing device 1710 typically includes at least some form of computer-readable media. Computer-readable media includes any available media that may be accessed by the computing device 1710. By way of example, computer-readable media include computer-readable storage media and computer-readable communication media.

The computing device 1710 illustrated in FIG. 17 is also an example of programmable electronics, which may include one or more such computing devices, and when multiple computing devices are included, such computing devices may be coupled together with a suitable data communication network so as to collectively perform the various functions, methods, or operations disclosed herein.

FIG. 18 is a block diagram illustrating additional physical components (e.g., hardware) of a computing device 1800 with which certain aspects of the disclosure may be practiced. Computing device 1800 may perform these functions alone or in combination with a distributed computing network such as those described with regard to FIGS. 16A and 16B which may be in operative contact with personal computing device 1618A, tablet computing device 1618B, and/or mobile computing device 1618C which may communicate and process one or more of the program engines described herein.

In a basic configuration, the computing device 1800 may include at least one processor 1802 and a system memory 1810. Depending on the configuration and type of computing device, the system memory 1810 may comprise, but is not limited to, volatile storage (e.g., random access memory), non-volatile storage (e.g., read-only memory), flash memory, or any combination of such memories. The system memory 1810 may include an operating system 1812 and one or more program engines 1814. The operating system 1812, for example, may be suitable for controlling the operation of the computing device 1800. Furthermore, aspects of the disclosure may be practiced in conjunction with a graphics library, other operating systems, or any other application program and are not limited to any particular application or system.

The computing device 1800 may have additional features or functionality. For example, the computing device 1800 may also include an additional data storage device (removable and/or non-removable) such as, for example, magnetic disks, optical disks, or tape. Such additional storage is illustrated in FIG. 18 by storage 1804. It will be well understood by those of skill in the art that storage may also occur via the distributed computing networks described in FIG. 18A and FIG. 18B. For example, computing device 1800 may communicate via network 1620 in FIG. 16A and data may be stored within network servers 1606 and transmitted back to computing device 1800 via network 1620 if it is determined that such stored data is necessary to execute one or more functions described herein. Additionally, computing device 1800 may communicate via network 1620 in FIG. 16B and data may be stored within network server 1606 and transmitted back to computing device 1800 via a network, such as network 1620, if it is determined that such stored data is necessary to execute one or more functions described herein.

As stated above, a number of program engines and data files may be stored in the system memory 1810. While executing on the processor 1802, the program engines described herein may perform processes including, but not limited to, the aspects described herein.

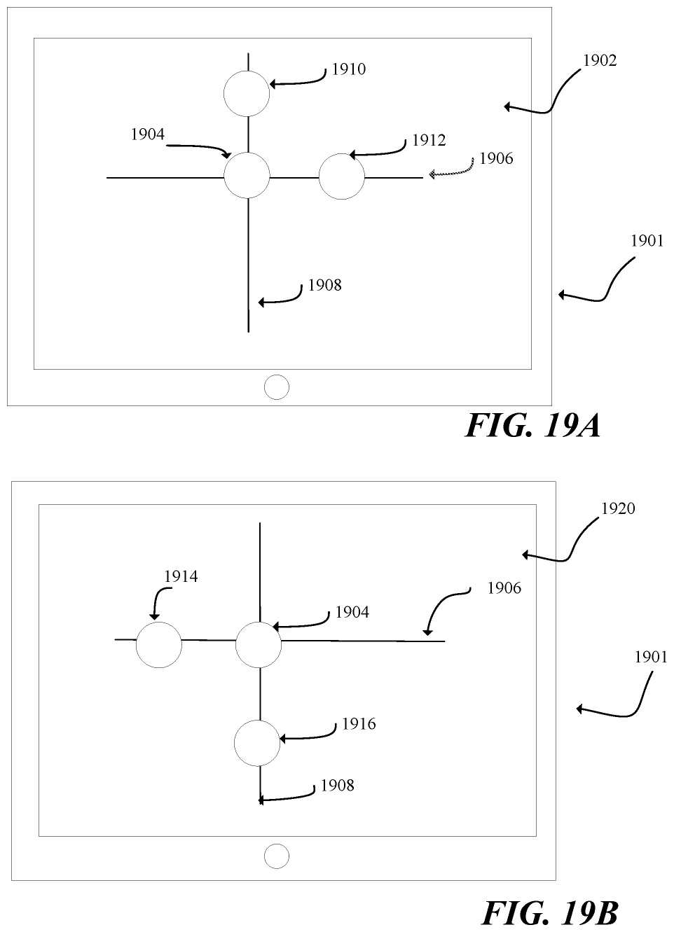

FIGS. 19A and 19B illustrate example graphical user interfaces 1902 and 1920 showing the deviations from modeled/predicted objects, expected objects, and imaged objects. As illustrated. GUIs 1902 and 1920 is displayed on a computer device 1901. While computing device 1901 is illustrated as a tablet, it will be appreciated that all manner of computing devices may display the GUI 1902, including the various computing devices described herein. It will be appreciated that like numbered elements have like properties. It will also be appreciated that other traits of objects may be displayed in the same style as GUIs 1902 and 1920. For example, deviations in color, object type, size, shape, etc. may be shown in a GUI similar to or the same as GUI 1902.

In examples, the X-axis 1906 illustrates the difference between the volume of imaged cuttings at the MMSM and the predicted volume of cuttings (e.g., based on a computer model). As one moves further from the 0 point, the differences get bigger. A negative value indicates that the predicted volume is less than that of what is imaged. Similarly, the y-axis 1908 is the difference between the volume of imaged cuttings at the MMSM and the expected volume (e.g., as expected by measurements in the downhole sensors and other operational readings. This may include bit depth, weight on bit, bit speed, fluid density, etc.).

With reference to FIG. 19A, as illustrated, GUI 1902 includes a first point 1904 showing the value of the imaged data, in this case, aggregate volume of cuttings imaged at one or more MMSM. The first point 1904 is located in the center of the GUI at an intersection of an x-axis 1906 and a y-axis 1908. A second point 1910 illustrates the calculated difference between the expected volume, for example 5 cubic feet per hour, and the volume of cuttings imaged at the MMSM. A third point 1912 illustrates the calculated difference between the volume of predicted cuttings, for example 2 cubic feet per hour, and the volume of cuttings imaged at the MMSM. One skilled in the art will appreciate that the x-axis and y-axis may be scaled as necessary.

Similarly, GUI 1920 includes a fourth point 1914, which illustrates the difference between the predicted volume and the volume of cuttings imaged at an MMSM, for example −5 cubic feet per hour. A fifth point 1916 illustrates the difference between the expected volume and the imaged volume, for example −2 cubic feet per hour.

The description and illustration of one or more embodiments provided in this application are not intended to limit or restrict the scope of the invention as claimed in any way. The embodiments, examples, and details provided in this application are considered sufficient to convey possession and enable others to make and use the best mode of claimed innovative technologies. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the general inventive concept embodied in this application that do not depart from the broader scope of the claimed invention.

1.-8. (canceled)

9. A computer-implemented method to adjust drilling parameters comprising:
determining that a drilling operation is at a steady state, wherein a steady state is determined by comparing imaged objects in object flow to expected objects;
based on determining that a drilling operation is at steady state, initiating a perturbation in the drilling operation, wherein the perturbation is a change from a current set point of one or more operational parameters;
after initiating the perturbation; receiving image data from one or more MMSMs;
analyzing the image data to determine whether the perturbation had a positive effect or negative effect;
determining the perturbation had a positive effect; and
maintaining the perturbation for a set period of time.

10. The computer-implemented method of claim 9, further comprising:
after the initiate perturbation operation, modifying the image data to be captured.

11. The computer-implemented method of claim 10, wherein modifying the image data to be captured comprises a modification to one or more selected from the group consisting of a number of ROIs, a size of an ROI, an image capture rate, a shutter speed of an imaging device, lighting at an image capture area, and a number of imaging devices capturing images.

12. The computer-implemented method of claim 10, further comprising:
after determining that the perturbation had a positive effect, sending the change from a current set point of one or more operational parameters and resulting image data to a predictive model.

13. The computer-implemented change of claim 9, wherein the one or more operational parameters is selected from the group consisting of a weight on bit, a drill speed, a fluid flow rate, and a fluid density.

14. The computer-implemented method of claim 9, wherein determining that the perturbation had a positive effect comprises;
determining that an increase in a volume of cuttings imaged at one or more MMSMs correspond to a predetermined calculated change.

15. The computer-implemented method of claim 9, wherein analyzing the image data comprises: preprocessing the image data and analyzing the image data using a DNN.

16. The computer-implemented method of claim 9, wherein the image data comprises an ROI of a falling zone of a shaker table.

17. A computer storage device storing instructions that, when executed, cause a computer to perform a method, the method comprising:
determining that a drilling operation is at a steady state, wherein a steady state is determined by comparing imaged objects in object flow to at least one selected from the group consisting of: expected objects and predicted objects;
based on determining that a drilling operation is at steady state, initiating a perturbation in the drilling operation; wherein the perturbation is a change from a current set point of one or more operational parameters;
after initiating the perturbation; receiving image data from one or more MMSMs;
analyzing the image data to determine whether the perturbation had a positive effect or negative effect;
determining the perturbation had a positive effect; and
maintaining the perturbation for a set period of time.

18. The computer storage device of claim 17, wherein the method further comprises;
after the initiate perturbation operation, modifying the image data to be captured.

19. The computer storage device of claim 18, wherein the modifying the image data to be captured comprises a modification to one or more selected from the group consisting of: a number of ROIs, an image capture rate, a shutter speed of an imaging device, lighting at an image capture area, and a number of imaging devices capturing images.

20. The computer storage device of claim 17, wherein the image data comprises an ROI of a falling zone of a shaker table.

21. The computer implemented method of claim of 9, wherein the comparing imaged objects in object flow to expected objects includes;
determining an imaged objects volume of cuttings; and
comparing the imaged objects volume of cuttings to an expected volume of cuttings.

22. The computer-implemented method of claim 9, wherein the expected objects are determined at least in part based on at least one selected from the group consisting of measured pressure, hookload, flow, torque, weight-on-bit (WOB), rate of penetration (ROP), rheology, and directional sensor information.

23. The computer-implemented method of claim 12, wherein the change from a current set point of one or more operational parameters updates the predictive model such that one or more drilling parameters are changed.

24. The computer-implemented method of claim 9, wherein the size and capture rate of the image data capture are set such that object flow is only imaged once.

25. A computer-implemented method to adjust drilling parameters comprising:
determining that a drilling operation is at a steady state, wherein a steady state is determined by comparing imaged objects in object flow to predicted objects;
based on determining that a drilling operation is at steady state, initiating a perturbation in the drilling operation, wherein the perturbation is a change from a current set point of one or more operational parameters;
after initiating the perturbation; receiving image data from one or more MMSMs;
analyzing the image data to determine whether the perturbation had a positive effect or negative effect;
determining the perturbation had a positive effect; and
maintaining the perturbation for a set period of time.

26. The computer implemented method of claim of 25, wherein the comparing imaged objects in object flow to predicted objects includes;
determining an imaged objects volume of cuttings; and
comparing the imaged objects volume of cuttings to a predicted volume of cuttings.

27. The computer-implemented method of claim 26, wherein the predicted objects are objects predicted by a computer model.

28. The computer-implemented method of claim 25, further comprising:
after receiving the image data from one or more MMSMs, preprocessing the image data by performing at least one selected from the group consisting: an image rotation, a white balancing, a brightness equalization, a cropping of the image data, a light correction, a color adjustment, a bit depth adjustment, and an aspect ratio adjustment.
